(19) United States
(12) Patent Application Publication
(10) Pub. No.: US 2026/0295673 A1
(43) Pub. Date: Oct. 1, 2026

(54) THREE-DIMENSIONAL PRINTING

(71) Applicants: PERIDOT PRINT LLC, Palo Alto, CA (US); NANYANG TECHNOLOGICAL UNIVERSITY, Singapore (SG)

(72) Inventors: Wei Xin TAN, Singapore (SG); Po-Ju CHIANG, Singapore (SG); Ting Fung ONG, Singapore (SG); Changquan LAI, Singapore (SG); John Samuel Dilip JANGAM, Palo Alto, CA (US)

(73) Assignees: PERIDOT PRINT LLC, Palo Alto, CA (US); NANYANG TECHNOLOGICAL UNIVERSITY, Singapore (SG)

(21) Appl. No.: 19/479,476

(22) PCT Filed: Apr. 28, 2023
(86) PCT No.: PCT/US2023/020395

§ 371 Date: Oct. 28, 2025

(51) Int. Cl. B22F 10/16; B22F 10/64; B33Y 10/00; B33Y 40/20; C22C 38/02; C22C 38/04; C22C 38/12

(52) U.S. Cl. CPC B22F 10/16; B22F 10/64; B33Y 10/00; B33Y 40/20; C22C 38/02; C22C 38/04; C22C 38/12; B22F 2301/35; B22F 2998/10; B22F 2999/00

(57) ABSTRACT

Examples of a three-dimensional (3D) printing method are disclosed. In one example method, an intermediate object is generated by i) forming a build material layer with build material particles, ii) based on data derived from a digital 3D model, applying a binder agent to at least a portion of the build material layer, the binder agent consisting of polyfurfuryl alcohol dissolved in an organic solvent, iii) evaporating the organic solvent and precipitating the polyfurfuryl alcohol out of solution by heating the build material layer to a first temperature, thereby binding the build material particles with precipitated polyfurfuryl alcohol in the at least the portion of the build material layer, and iv) repeating the spreading, selectively applying, and the heating steps. A carbon residue is then produced from the precipitated polyfurfuryl alcohol throughout the intermediate object by heating the intermediate object to a second temperature.

### BACKGROUND

Three-dimensional (3D) printing is an additive manufacturing process used to make 3D printed articles from a digital model. 3D printing generally involves the application of successive layers of print material, such as a build material, one or more agents, and/or other printing material(s) to create the final 3D printed article. This is unlike traditional machining processes, which often rely on the removal of material to create the final 3D article. 3D printing is often used in rapid product prototyping, mold generation, mold master generation, and short run manufacturing for mass personalization and customization of goods.

### BRIEF DESCRIPTION OF THE DRAWINGS

Features of examples of the present disclosure will become apparent by reference to the following detailed description and drawings, in which like reference numerals correspond to similar, though perhaps not identical components. For the save of brevity, reference numerals or features having a previously described function may or may not be described in connection with other drawings in which they appear.

FIG. 1A through FIG. 1F together schematically illustrate examples of a 3D printing method using metal, semi-metal, metal alloy, or ceramic build materials according to Implementation 1 of the present disclosure, where FIG. 1A depicts supplying the build material particles to form a layer, FIG. 1B depicts selective application of the binder agent to the build material layer, FIG. 1C depicts heating the build material layer to precipitate polyfurfuryl alcohol out of the binder agent and form a patterned layer, FIG. 1D depicts a build material cake including an intermediate object formed after repeating the processes of FIG. 1A through FIG. 1C, FIG. 1E depicts removal of unpatterned build material from the build material cake, and FIG. 1F depicts sintering of the intermediate object to form a 3D object.

FIG. 2 is a schematic illustration of an example 3D printing system.

FIG. 3A through FIG. 3C together schematically illustrate one example of a 3D printing method using a polymeric build material according to Implementation 2 of the present disclosure, where FIG. 3A depicts supplying the build material particles to form a layer, FIG. 3B depicts selective application of the binder agent to the build material layer, and FIG. 3C depicts heating the build material layer to precipitate polyfurfuryl alcohol out of the binder agent and form a 3D object layer.

FIG. 3A, FIG. 3B, FIG. 3D and FIG. 3E together schematically illustrate another example of a 3D printing method using a polymeric build material according to Implementation 2 of the present disclosure, where FIG. 3A depicts supplying the build material particles to form a layer, FIG. 3B depicts selective application of the binder agent to the build material layer, FIG. 3D depicts selective application of a detailing agent to the build material layer, and FIG. 3E depicts heating the build material layer to precipitate polyfurfuryl alcohol out of the binder agent and coalesce the build material to form a 3D object layer.

FIG. 4 is a graph depicting compressive strength (MPA, Y axis) for five sample 3D printed objects (including two comparative samples (4 and 5) and three example samples (1, 2, and 3) printed with the binder agent disclosed herein).

FIG. 5 is a graph depicting storage modulus (MPa, Y axis) versus the frequency (Hz, X axis) for three of the sample 3D printed objects (including the two comparative samples (latex and carbon nanoparticles) and one of the example sample printed with the binder agent (PFA) disclosed herein).

FIG. 6A through FIG. 6D are optical microscopy images, reproduced in black and white, of four of the sample 3D printed objects (example samples printed with the binder agent disclosed herein).

FIG. 7A is a graph depicting stress (N/mm², Y axis) versus strain (%, X axis) for three of the sample 3D printed objects (example samples printed with the binder agent disclosed herein).

FIG. 7B is a graph depicting hardness (Hv, Y axis) versus carbon concentration (%, X axis) for five of the sample 3D printed objects (example samples printed with the binder agent disclosed herein).

FIG. 8A is a schematic top view of a sample generated with carbon rich and carbon poor section.

FIG. 8B is a schematic cross-section view of the sample of FIG. 8A taken along line 8B-8B of FIG. 8A.

FIG. 8C is a graph depicting the Vicker's hardness (HV, Y axis) versus the distance (mm, X axis) across the portion of the sample identified by the dashed line in FIG. 8B, with the corresponding cross-section depicted at the bottom of the graph.

FIG. 9A is a schematic illustration of dogbone samples (top image) and a schematic cross-sectional view (bottom image) of the dogbones illustrating carbon rich and carbon poor areas, where the figure also illustrates the pull directions during a tensile test and the dimensions of the dogbones.

FIG. 9B is a greyscale reproduction of a digital image correlation (DIC) of the dogbone illustrating surface strain during the tensile testing (top image is tension at 270 seconds and bottom image is tension at 350 seconds).

FIG. 9C is a graph depicting stress (N/mm², Y axis) versus strain (%, X axis) for the dogbones.

### DETAILED DESCRIPTION

Additive manufacturing processes may be used to form three-dimensional (3D) objects from various build materials including metals, metal alloys, ceramics, and polymers. One additive manufacturing process is binder jetting, which involves printing (e.g., using inkjet printing) a binder agent onto select portions of a build material layer formed from build material particles. When the binder agent includes a polymer binder, the process may further involve curing the polymer binder, which temporarily binds the build material particles together to form an intermediate object. For metal, semi-metal, metal alloy, and ceramic build materials, the intermediate object is exposed to multiple stages of heating, first to debind the intermediate object (i.e., remove the polymer binder) and then to sinter the build material particles, which coalesces the particles together and forms the 3D object. While other additive manufacturing processes, such as material jetting and powder bed fusion, are more commonly used for polymer build materials, binder jetting can also be employed. With polymer build materials, the binder in the binder agent acts as an adhesive to bind the build material particles together to form the 3D object. As such, high temperature post printing heating (i.e., debinding and sintering) is not performed when binder jetting polymer build materials.

In some instances, the binder agent that is printed during the binder jetting process is a fluid including a polymer binder that is dissolved or dispersed in an aqueous liquid vehicle. The aqueous liquid vehicle evaporates during printing and/or curing. With metal, semi-metal, metal alloy, and ceramic build materials, it may be desirable to remove the polymer binder, e.g., during debinding, to avoid the formation of a residue that could alter the composition, and therefore the material properties, of the final 3D object.

However, there are some instances where altering the material properties of the final 3D part is desirable, such as to increase strength or ductility of the part. With metal or metal alloy build materials, altering the material properties of the final 3D part has been achieved by in-situ alloying or carburizing of the build material with particles incorporated into the binder agent. However, the presence of the particles in the binder agent may increase clogging of printhead nozzles during 3D printing, which is at least partially due to large particle sizes, particle sedimentation, and/or non-uniform dispersion of the additional particles. Moreover, the total amount of the particles that can be added through the binder agent is limited, because excess binder agent fluid can lead to oversaturation of the build material layer and bleeding of the binder agent into areas of the layer that are not to be patterned. This can lead to distortion of the 3D object.

Still further, the use of polymer binders in the aqueous liquid vehicle can extend the overall production time of the 3D object, due to the time it takes for water evaporation and then binder curing.

The inventors of the present disclosure have discovered a binder agent that can be used with any of the following build materials: metals, metal alloys, ceramics, and polymers. The binder agent consists of polyfurfuryl alcohol dissolved in an organic solvent that rapidly evaporates during the printing process. Upon organic solvent evaporation, the polyfurfuryl alcohol is sticky, and thus is capable of adhering the build material particles together without a prolonged curing process. Thus, the rapid evaporation and adhesion reduces the overall production time of the 3D printed object, regardless of the build material used.

Moreover, when the binding agent disclosed herein is used with metal, semi-metal, metal alloy, or ceramic build material particles, the polyfurfuryl alcohol has both binding and doping capabilities. As described, polyfurfuryl alcohol has binding capability, because the polymer binder causes the particles of the build material to adhere or stick to one another upon evaporation of the organic solvent. Polyfurfuryl alcohol also has doping capability, because the polymer binder decomposes when heated to produce a carbon residue that is capable of dissolving into, and thus diffusing into, the metal, semi-metal, metal alloy, or ceramic particles used to form the 3D object. Details of the binding and alloying capabilities of poly(furfuryl alcohol) are discussed below.

The present disclosure provides two implementations, and several examples are provided for each of the two implementations. The first implementation (“Implementation 1”) covers a 3D printing method for forming a 3D part from metal, semi-metal, metal alloy, or ceramic build materials. The second implementation (“Implementation 2”) covers a 3D printing method for forming a 3D part from a polymeric build material. Implementation 1 will be described first, and Implementation 2 will be described afterwards. In addition to implementations 1 and 2, the binder agent may be used in other processes as will be described in the section “Other Implementations.”

### Implementation 1

In Implementation 1, the 3D printing method uses metal, semi-metal, metal alloy, or ceramic build material particles to generate an intermediate object, which is subsequently exposed to higher temperatures to form a final 3D object. This 3D printing method utilizes the binder agent disclosed herein for both binding and doping, as mentioned above.

### Binder Agent

The binder agent for the 3D printing method of Implementation 1 consists of an organic solvent and polyfurfuryl alcohol dissolved in the organic solvent.

Polyfurfuryl alcohol is sticky and highly viscous when in its molten state, rendering polyfurfuryl alcohol as a suitable temporary polymer binder for binding metal, semi-metal, metal alloy, or ceramic build material particles together to form an intermediate. Polyfurfuryl alcohol is also a suitable dopant source, as polyfurfuryl alcohol decomposes to produce a carbon residue when heated above 400° C. The carbon residue dissolves into and diffuses throughout the softened build material particles during sintering. In other words, the carbon residue alloys or dopes the coalescing build material particles of the 3D printed object. Further details of the alloying/doping property of the polyfurfuryl alcohol are described below.

Polyfurfuryl alcohol is produced by polymerizing furfuryl alcohol. First, furfuryl alcohol is synthesized by hydrogenation of furfural, which is an organic substance produced from waste bio-mass and has the chemical formula C₄H₃OCHO. Furfural includes an aldehyde attached to the 2-position of furan and may be referred to as furan-2-carbaldehyde. During the hydrogenation reaction, the furfural reacts with hydrogen (H₂) to produce furfuryl alcohol as shown in the reaction scheme (1) below:

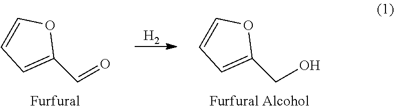 [SMILES: O=Cc1ccco1 ; "H2" ; OCc1ccco1]

Polyfurfuryl alcohol (which is a furan resin) is the reaction product of furfuryl alcohol polymerized in the presence of an acid catalyst and at a suitable temperature. Both strong and weak acids may be used as the acid catalysts. It is to be understood, however, that weaker acids may involve a longer reaction time (e.g., 24 hours or more) than stronger acids. Examples of suitable acid catalysts include Lewis acids, such as H⁺, K⁺, Mg²⁺, Fe³⁺, BF₃, CO₂, SO₃, AlCl₃, and Br₂. Other suitable acids include H₂SO₄, H₃PO₄, HCl, C₂HCl₃O₂, C₄H₂Cl₃O₂, or other Brønsted-Lowry acids. The weight ratio of the acid catalyst to the furfuryl alcohol ranges from 99:1 to 1:99, and can be adjusted based upon a desired reaction time. In an example, the weight ratio of the acid catalyst to the furfuryl alcohol ranges from 1:15 to 1:40, and in another example, the weight ratio of the acid catalyst to the furfuryl alcohol ranges from 1:16 to 1:33. In one specific example, the acid catalyst is sulfuric acid (H₂SO₄). In an example, the sulfuric acid catalyst is a 1.8M sulfuric acid solution, and the weight ratio of sulfuric acid solution to furfuryl alcohol is about 1:33. The polymerization reaction occurs by polycondensation of one furfuryl alcohol monomer with another in the presence of an active hydrogen from the acid catalyst. The reactants are heated (e.g., to about 50° C.) and mixed until boiling. The polymerization reaction is shown by the reaction scheme (2) below:

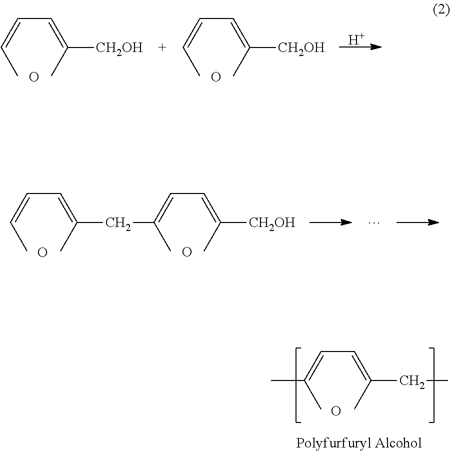

After boiling occurs for a predetermined time period (e.g., from about 15 seconds to about 45 seconds), a base may be added to neutralize the furfuryl alcohol/acid solution, which now contains polyfurfuryl alcohol. In an example, a 10M sodium hydroxide solution may be added for neutralization, and the weight ratio of the sodium hydroxide solution to the furfuryl alcohol solution (which includes the acid catalyst) ranges from about 1:30 to about 1:69, and the pH ranges from about 5 to about 8. In one example, the weight ratio of the sodium hydroxide solution to the furfuryl alcohol solution is 1:68.5. Neutralization consumes the catalyst, and thus stops the polymerization reaction if any unreacted furfuryl alcohol is present. Neutralization may be desirable so that unreacted acid catalyst is not carried over into the binder agent. The strong acid could deleteriously affect the printhead used to print the binder agent.

The polyfurfuryl alcohol is separated from the neutralized solution, which includes water as a neutralization by-product. Separation may be performed using centrifugation and decantation, filtering, or the like.

Once separated, the polyfurfuryl alcohol may be heated in an oven at a temperature sufficient to evaporate remaining water without hardening the polyfurfuryl alcohol. In any example, this heating is performed by incubating the separated solution in the oven (or other suitable heating mechanism) at about 50° C. for about 2 hours. The resulting polyfurfuryl alcohol is in the form of a viscous liquid resin.

The polyfurfuryl alcohol is then dissolved in an organic solvent to form the binder agent. The amount of polyfurfuryl alcohol incorporated into the organic solvent will depend upon the organic solvent used and the solubility of polyfurfuryl alcohol in that solvent. In an example, the polyfurfuryl alcohol is present in an amount of from about 1 wt % to about 10 wt %, based on the total weight of the binder agent. In another example, the polyfurfuryl alcohol is present in an amount of from about 2 wt % to about 8 wt %, based on the total weight of the binder agent. In another example, polyfurfuryl alcohol is present in an amount of from about 4 wt % to about 6 wt %, based on the total weight of the binder agent. In a particular example, the binder agent includes about 5 wt % of the polyfurfuryl alcohol, based on the total weight of the binder agent.

The organic solvent can be a polar organic solvent and/or a non-polar organic solvent that dissolves the polyfurfuryl alcohol. Examples of suitable polar organic solvents include acetone, methanol, 2-methoxyethanol, isopropanol, and dimethyl sulfoxide. Examples of suitable non-polar organic solvents include toluene, ethyl acetate, and butyl acetate. Combinations of any of the listed solvents may also be used. In an example, the organic solvent is acetone. In another example, the organic solvent is a combination of acetone and 2-methoxyethanol. This particular combination may be desirable to slow down the evaporation time during the printing methods disclosed herein, e.g., compared to when acetone alone is used. The organic solvent makes up the balance of the binder agent.

It is to be understood that the polyfurfuryl alcohol is completely dissolved in the organic solvent such that the binder agent is free of particles or solids. The particle- or solid-free binder agent dries quickly during heating (due, at least in part, to the solvent(s) that is/are used), and nozzle clogging is reduced or even prevented (due, at least in part, to the lack of solids). In an example, the binder agent is considered to be free of particles or solids when the particle or solid content is less than 1 wt %, based on the total weight of the binder agent. In a particular example, the binder agent is entirely free of particles or solids, i.e., the particle or solid content is 0 wt %.

As mentioned above, the binder agent consists of the organic solvent and the polyfurfuryl alcohol dissolved in the organic solvent. In this example, the binder agent does not include any additional components, such as additives. Other examples of the binder agent include one or more additives, such as colored pigments, silicon nanoparticles, and carbon black nanoparticles. Colored pigments may be used to achieve a desired aesthetic, silicon nanoparticles may be used to allow steel build materials into electrical steel, and carbon black nanoparticles can be used to further increase the carbon content. When these additive(s) is/are included, the total amount of any one of the additives ranges from about 3 wt % to about 20 wt % of a total weight of the binder agent. In these examples, the solids content of the binder agent may be up to 20%, depending upon how much of the additive(s) is/are included.

### Build Material

The build material for the 3D printing method of Implementation 1 includes build material particles selected from the group consisting of metal particles, semi-metal particles, metal alloy particles, ceramic particles, and combinations thereof. In an example, these build material particles are in powder form. In another example, these build material particles are in the form of a powder-like material, which includes, for example, short fibers having a length that is greater than its width. In some examples, the powder or powder-like material may be formed from, or may include, short fibers that may, for example, have been cut into short lengths from long strands or threads of material. As a powder, the build material may also be referred to as a dry or solid build material.

The metal particles for the build material may be any particulate single phase metallic particles composed of a single element. The metal particles may have the ability to sinter into a continuous body to form a sintered part when heated to a sintering temperature. Typically, the sintering temperature of the metal particles is below the melting point of the single element. The term “continuous body” refers to the metal particles merged together to form a single part with sufficient mechanical strength to meet the requirements of a desired final 3D object. Any single element metal may be used for the metal particles. Specific examples of metals include silver, copper, cobalt, tungsten, titanium, iron, platinum, aluminum, and/or nickel.

Semi-metal particles may also be used, such as particles of boron, silicon, germanium, antimony, and/or tellurium.

The metal alloy particles for the build material are particles composed of two or more elements, which may be in the form of a single phase metallic alloy or a multiple phase metallic alloy. For metal alloys, sintering generally occurs over a range of temperatures. Examples of metal alloys include low-carbon to medium-carbon stainless steels, ferrous alloys, or titanium alloys. In low-carbon stainless steel, the carbon level is 0.3% or less. In medium-carbon stainless steel, the carbon level ranges from about 0.31% to about 0.6%. Specific alloy examples include stainless steel 304/304L (low-carbon), stainless steel GP1 (low-carbon), stainless steel 17-4PH (low-carbon), stainless steel 316/316L (low-carbon), stainless steel 430L (low carbon), titanium 6Al4V, and titanium 6Al-4V ELI7. One example of a low-carbon stainless steel is manganese steel, which is an alloy of iron, manganese, carbon, molybdenum, and possibly silicon. The specific composition of one example of manganese steel powder includes about 0.11% carbon, about 1.5% manganese, about 0.5% molybdenum, less than 0.05% silicon, and a balance of iron. While several example alloys have been provided, it is to be understood that other alloys may be used.

In an example of the method, the metal alloy particles selected for the build material are steel particles having a carbon content of 0.3% or less (i.e., low-carbon steel). In another example of the method, the metal alloy particles selected for the build material are manganese steel particles.

The ceramic particles for the build material include metal oxides, inorganic glasses, carbides, nitrides, borides, and/or combinations thereof. Some specific examples of ceramic particles include alumina (Al₂O₃), Na₂O/CaO/SiO₂ glass (soda-lime glass), silicon carbide (SiC), silicon nitride (Si₃N₄), silicon dioxide (SiO₂), zirconia (ZrO₂), titanium dioxide (TiO₂), iron oxide (Fe₃O₄), hafnia (HfO₂), barium titanate (BaTiO₃), tungsten carbide (WC), lead zirconate titanate (PZT), hydroxyapatite, or combinations thereof. As an example of one suitable combination, 30 wt % glass may be mixed with 70 wt % alumina.

The build material particles may be similarly sized particles or differently sized particles. In one example, the average particle size of the build material particles can range from 0.5 μm to 200 μm. As used herein, the term “average particle size” refers to the average diameter of the particles in a distribution of particles. In some examples, the build material particles can have an average particle size that can range from about 2 μm to about 150 μm, or from about 1 μm to about 100 μm, or from about 1 μm to about 50 μm, etc. In a distribution of particles, the “D50 particle size” is the medium diameter, and about half of the particles in the distribution are larger than the D50 particle size and about half of the other particles are smaller than the D50 particle size.

In addition, the build material particles may be non-spherical, spherical, or random shapes, or combinations of these shapes may be present in a distribution of particles. For spherical particles, the particle size of any given particle may be the diameter of the particle. For non-spherical or randomly shaped particles, the particle size of any given particle may be an average of several diameters across the particle.

The metal, semi-metal, metal alloy, or ceramic build material particles are part of a build material composition used to form the build material layer in the 3D printing method of Implementation 1. In some instances, the build material composition consists of the build material particles. In other instances, the build material particles are included in the build material composition with other additives. In an example, the build material composition includes from about 80 wt % to 100 wt % of the build material particles, based on the total weight of the build material composition. In other examples, the build material composition includes build material particles present in amounts ranging from about 90 wt % to 100 wt %, or from about 95 wt % to 100 wt %, or in an amount of 100 wt %, all based on the total weight of the build material composition. When the build material composition is made up entirely of the metal, semi-metal, metal alloy, or ceramic build material particles, these build material particles account for 100% of the composition. When the build material particles are present in the build material composition in an amount less than 100 wt %, the remainder of the build material composition may be made up of one or more of the additives. An example of an additive is a flow aid.

The flow aid may be added to the build material to improve the flowability of the build material during layer formation. Flow aids may be particularly beneficial when the build material has an average particle size of less than 25 μm. The flow aid improves the flowability of the build material by reducing the friction, the lateral drag, and the tribocharge buildup (by increasing the particle conductivity). Examples of suitable flow aids include aluminum oxide (Al₂O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based upon the total weight of the build material composition.

Other additives that may be included in the build material include carbon black particles. This additive may be desirable for obtaining high carbon steel or cast iron 3D printed objects.

### 3D Printing Method

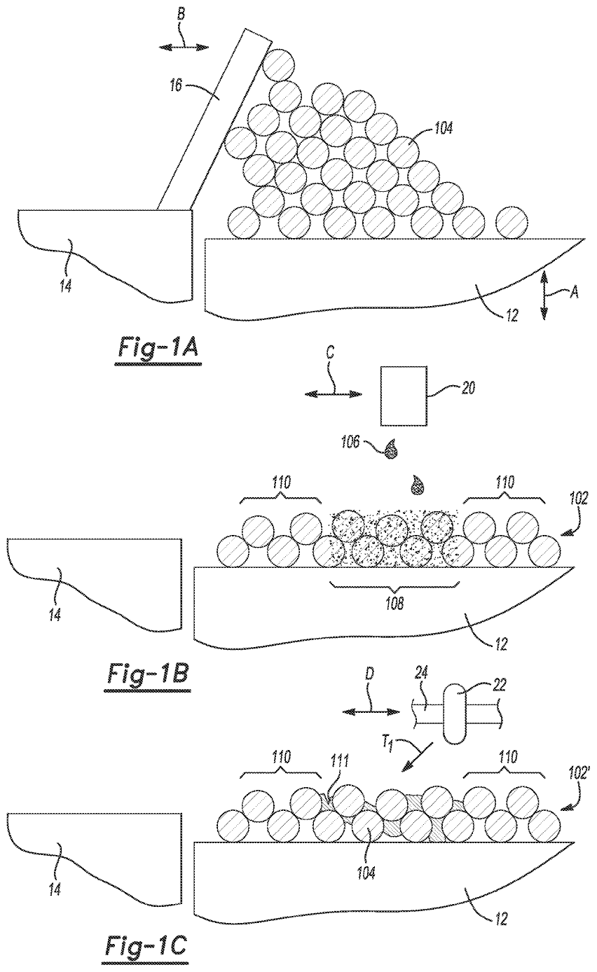

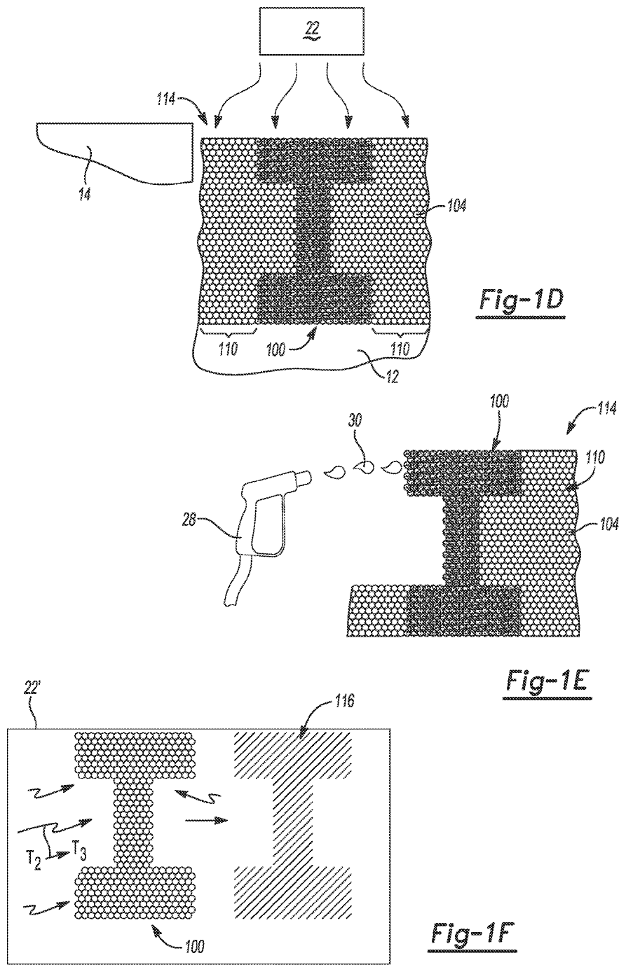

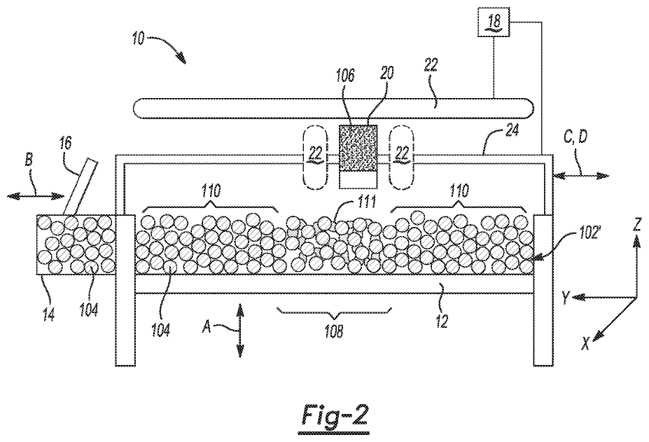

A 3D printing method utilizing the metal, semi-metal, metal alloy, or ceramic build material particles is described below with reference to FIG. 1A through FIG. 1F. The 3D printing method comprises generating an intermediate object by i) forming a build material layer with build material particles (FIG. 1A), ii) based on data derived from a digital 3D object model, selectively applying a binder agent to at least a portion of the build material layer (FIG. 1B), the binder agent consisting of an organic solvent and polyfurfuryl alcohol dissolved in the organic solvent, iii) evaporating the organic solvent and precipitating the polyfurfuryl alcohol out of solution by heating the build material layer to a first temperature, thereby binding the build material particles with precipitated polyfurfuryl alcohol in the at least the portion of the build material layer (FIG. 1C), and iv) repeating the forming, the selectively applying, and the heating (FIG. 1D). The 3D printing method further comprises producing a carbon residue from the precipitated polyfurfuryl alcohol and throughout the intermediate object by heating the intermediate object to a second temperature, thereby decomposing (FIG. 1E). In an example, the method further includes sintering the intermediate object and forming a final 3D part by heating the intermediate object to a third temperature that is higher than the second temperature (FIG. 1F).

The 3D printing method used to generate the intermediate object 100 (shown at least in FIG. 1D) utilizes a 3D printing system 10 (an example of which is shown in FIG. 2) to iteratively apply and pattern individual layers 102 of build material particles 104. As noted above, the build material particles 104 for Implementation 1 of the 3D printing method are selected from the group consisting of metal particles, semi-metal particles, metal alloy particles, ceramic particles, and combinations thereof. In the method, the particles 104 may be part of any of the build material compositions disclosed herein.

An example of the 3D printing system 10 is shown in FIG. 2 and is described throughout the discussion of FIG. 1A through FIG. 1F. The 3D printing system 10 includes a build area platform 12, a build material supply 14 containing the build material particles 104, and a build material distributor 16.

The 3D printing method includes applying the build material particles 104 to the build area platform 12 or to a previously patterned build material layer (see reference numeral 102′ in FIG. 1C). FIG. 1A illustrates the initial application of the build material particles 104 onto the build area platform 12 (where no build material layer 102 has been formed). The particles 104 are spread to form an individual layer 102 (see FIG. 1B). The individual layer 102 of the build material particles 104 is referred to herein as the build material layer 102.

The build area platform 12 receives the build material particles 104 from the build material supply 14. The build area platform 12 may be moved in a direction as denoted by the arrow A in FIGS. 1A and 1n FIG. 2, e.g., along the z-axis, so that the build material particles 104 are applied (e.g., delivered) to the build area platform 12 or to a previously patterned build material layer 102′. As used herein, a “patterned layer” or “patterned build material layer” refers to the build material layer 102 having the binder agent 106 applied to at least a portion 108 thereof and having the organic solvent removed therefrom.

In an example, when the build material particles 104 are to be applied or delivered, the build area platform 12 is programmed to advance (e.g., downward) enough so that the build material distributor 16 can push the build material particles 104 onto the build area platform 12 to form a substantially uniform build material layer 102 thereon. The build area platform 12 is also returned to its original position, for example, when a new intermediate object 100 is to be built.

The build material supply 14 may be a container, bed, or other surface that positions the build material particles 104 between the build material distributor 16 and the build area platform 12.

The applied build material particles 104 form the build material layer 102. In some examples, the 3D printing method further includes spreading the build material particles 104 to form the build material layer 102. For example, the build material distributor 16 moves in one of the directions as denoted by the arrow B in FIGS. 1A and 1n FIG. 2, e.g., along the y-axis, over the build material supply 14 and across the build area platform 12 to spread the build material particles 104 and form the build material layer 102 over the build area platform 12. In this example, the build material distributor 16 is returned to a position adjacent the build material supply 14 following the spreading of the build material particles 104. The build material distributor 16 may be a blade (e.g., a doctor blade), a roller, a combination of a roller and a blade, and/or any other device capable of spreading the build material particles 104 over the build area platform 12. In an example, the build material distributor 16 is a counter-rotating roller. In other examples, the build material supply 14 or a portion of the build material supply 14 may translate along with the build material distributor 16 such that build material particles 104 are delivered continuously to the build area platform 12 rather than being supplied from a single location at the side of the printing system 10 as depicted in FIG. 1A and FIG. 2.

Still with reference to FIG. 1A and to FIG. 2, the build material supply 14 supplies the build material particles 104 into a position so that the build material particles 104 are ready to be spread onto the build area platform 12. The build material distributor 16 spreads the supplied build material particles 104 onto the build area platform 12. A controller (identified by reference numeral 18 in FIG. 2) processes data according to a digital 3D object model. In an example, the controller 18 processes control supply data according to the digital 3D object model and, in response, controls the build material supply 14 to appropriately position the build material particles 104. The controller 18 also processes control spreader data according to the digital 3D object model and, in response, controls the build material distributor 16 to spread the supplied build material particles 104 over the build area platform 12 to form the build material layer 102. In other examples (not shown), the build distributor 16 could sprinkle the build material particles 104 over the build area platform 12 to form the build material layer 102 thereon. While several examples have been provided, it is to be understood that other techniques may be used to substantially uniformly apply the build material particles 104. As shown in FIG. 1B, one (i.e., a single) build material layer 102 has been formed.

The build material layer 102 that is formed has a substantially uniform thickness across the build area platform 12 (or previously patterned build material layer 102′). In an example, the thickness of the build material layer 102 is about 100 μm. In another example, the thickness of the build material layer 102 ranges from about 30 μm to about 300 μm, although thinner or thicker layers may also be used. For example, the thickness of the build material layer 102 may range from about 20 μm to about 500 μm, or from about 50 μm to about 80 μm. The layer 102 thickness may be about 2× (i.e., 2 times) the particle 104 diameter at a minimum for finer part definition. In some examples, the layer 102 thickness may be about 1.5× the particle 104 diameter.

The 3D printing method further includes selectively applying, based on data derived from the digital 3D object model, the binder agent 106 to at least a portion 108 of the build material layer 102. As described herein, the binder agent 106 consists of the organic solvent and the polyfurfuryl alcohol dissolved in the organic solvent. As shown in FIGS. 1B and 1n FIG. 2, the binder agent 106 is selectively applied to the build material layer 102 at the portion 108. The binder agent 106 may be dispensed from an applicator 20, such as a thermal inkjet printhead, a piezoelectric printhead, a continuous inkjet printhead, etc., and the selectively applying of the binder agent 106 may be accomplished by thermal inkjet printing, piezoelectric inkjet printing, continuous inkjet printing, etc. The applicator 20 includes a reservoir of the binder agent 106 or is fluidly coupled to a separate supply of the binder agent 106.

The applicator 20 is responsive to commands from the controller 18, which directs the applicator 20 to iteratively apply the binder agent 106 to the build material layer 102 at the desired portion(s) 108. The controller 18 (shown in FIG. 2) processes data, again according to the digital 3D object model, to direct the applicator 20. For example, the controller 18 processes data for a corresponding build material layer 102 within the digital 3D object model. In response, the controller 18 controls the applicator 20 (e.g., in the directions indicated by the arrow C in FIG. 1B and FIG. 2) to deposit the binder agent 106 onto the predetermined or selected portion(s) 108 of the build material layer 102. The predetermined or selected portion(s) 108 of the build material layer 102 become part of the intermediate object 100 (and ultimately the final 3D object 116, see FIG. 1F). In the example shown in FIG. 1B, the applicator 20 selectively applies the binder agent 106 on that/those portion(s) 108 of the build material layer 102 that is/are to become a first layer of the intermediate object 100.

The selective application of the binder agent 106 deposits the binder agent 106, consisting of the polyfurfuryl alcohol dissolved in the organic solvent, onto the build material layer 102. The organic solvent of the binder agent 106 is capable of wetting the build material particles 104 of the build material layer 102, and penetrating into the microscopic pores/voids of the build material layer 102 (i.e., spaces between the build material particles 104). The polyfurfuryl alcohol, which precipitates out of solution during solvent evaporation, will then exist in these microscopic pores/voids to hold the materials particles 104 together. The amount of the polyfurfuryl alcohol that is introduced into the portion(s) 108 of the build material layer 102 via the binder agent 106 is sufficient to bind the build material particles 104 together.

It is to be understood that the selective application of the binder agent 106 may be accomplished in a single printing pass or in multiple printing passes. In some examples, the binder agent 106 is selectively applied in a single printing pass. In some other examples, the binder agent 106 is selectively applied in multiple printing passes. In one of these examples, the number of printing passes ranges from 2 to 4. It may be desirable to apply the binder agent 106 in multiple printing passes to increase the amount, e.g., of the polyfurfuryl alcohol that is applied to the layer 102, to avoid liquid splashing, to avoid displacement of the build material particles 104, etc.

There may be portions 110 of the build material layer 102 that do not have the binder agent 106 applied thereto. It should be understood that these portions 110 of the build material layer 102 also do not have the polyfurfuryl alcohol binder introduced thereto. As such, the portions 110 of the build material layer 102 do not become part of the intermediate object 100 or part of the final 3D object 116 that is ultimately formed.

The 3D printing method further includes evaporating the organic solvent and precipitating the polyfurfuryl alcohol out of solution by heating the build material layer 102 to a first temperature T₁. FIG. 1C illustrates this heating step, which may also be referred to herein as drying. In essence, the selectively applied binder agent 106 is heated to the first temperature T₁ to evaporate the organic solvent and to precipitate the polyfurfuryl alcohol out of solution. The precipitated polyfurfuryl alcohol 111 is sticky, and thus is able to hold adjacent build material particles 104 together wherever the binding agent 106 had been deposited. The bound particles 112 in the patterned build material layer 102′ are shown in FIG. 1C.

The first temperature T₁ is a temperature sufficient to effect the evaporation of the organic solvent, which enables the precipitation of the polyfurfuryl alcohol. The first temperature T₁ is dependent, at least in part, on the type of organic solvent used in the binder agent 106. The first temperature T₁ also helps to keep the build material particles 104 dry. In an example, the first temperature T₁ ranges from about 45° C. to about 150° C. In another example, the first temperature T₁ ranges from about 70° C. to about 100° C., or from about 70° C. to about 120° C., or from about 100° C. to about 150° C., or from about 40° C. to about 60° C., or from about 140° C. to about 150° C. In an example, the first temperature T₁ is about 45° C.

While application of the binder agent 106 and heating to the first temperature T₁ are shown in separate figures, it is to be understood that heating at the first temperature T₁ takes place as the binder agent 106 is applied to the individual layers 102 throughout the formation of the intermediate object 100. As such, the build material platform 12 is maintained at the first temperature T₁ while the binding agent 106 is applied to the portion(s) 108. Heating at the low temperature throughout the formation of the intermediate object 100 helps to reduce bleeding of the binder agent 106 and distortion of the desired 3D object dimensions. When the first temperature T₁ is maintained throughout the formation of the intermediate object 100, the layer 102 application and binder agent selective application may be performed continuously.

The 3D printing system 10 may include temperature sensors (not shown). At the outset of the printing method, the sensors detect the then-current temperature, and then the 3D printing system 10 can adjust the heating time to reach the first temperature T₁ before the layer 102 of the build material composition is applied.

In other examples, the binder agent 106 is applied and then the layer 102 is heated to the first temperature T₁. In this example, the first temperature T₁ is not maintained throughout the printing process, but rather is raised and lowered layer by layer. The heating time for each layer 102 depends upon the volatility and evaporation rate of the organic solvent that is used. Because evaporation may take place within a fraction of a second of the binder agent 16 being applied or within about 1 hour of the binder agent 16 being applied at the first temperature T₁, the heating time can be from about 0.1 seconds to about 1 hour per layer. The total heating time when generating the intermediate object 100 will depend upon the number of layers 102, 102′, and the heating time per layer.

The heat used for evaporation and precipitation is provided by a heater 22, which may be positioned to heat the build material particles 104 on the build area platform 12. In some examples, as shown in FIG. 2, the heater 22 can be a stationary heater that is positioned above the build area platform 12, and thus above the layers 102. In other examples, as shown in FIGS. 1C and 1n phantom in FIG. 2, the heater 22 can be affixed to a carriage 24 that moves the applicator 20, and thus the heater 22 can be translated back and forth (e.g., in the directions indicated by the arrow D) with the applicator 20 above the build area platform 12, and thus above the layers 102. In still other examples, the build area platform 12 itself can be heated. In yet further examples, heaters 22 can also be positioned on the sides of the build area platform 12. A combination of any of these heater 22 positions can also be used.

The 3D printing method further includes repeating the forming, the selectively applying, and the heating steps, which generates the intermediate object 100. In essence, the method steps described above in connection with FIGS. 1A through 1C are repeated to iteratively build up several patterned build material layers 102′ to form the intermediate object 100 (shown in FIG. 1D). In particular, the method includes repeating the forming of the build material layer 102 with the build material particles 104, the selectively applying of the binder agent 106, and the heating of the layer 102 (with the binder agent 106 thereon) to form additional patterned layers 102′. The processes may be repeated once, twice, or several times to generate the intermediate object 100, and the number of times depends upon the 3D object model being used.

Alternatively, the forming of the build material layer 102 with the build material particles 104 and the selectively applying of the binder agent 106 could be repeated (once, twice, or several times) to form layers 102 with the binder agent 106 applied thereto, and then all of the layers (with the binder agent 106) are exposed to heating at the same time to evaporate the solvent, form the precipitated polyfurfuryl alcohol 111, and generate the intermediate object 100. This example may be desirable when binder agent 106 bleeding is less likely due to rapid solvent evaporation (e.g., with acetone).

In either example, a build material cake 114, as shown in FIG. 1D, is formed, which includes the intermediate object 100 residing within the non-patterned portions 110 of each of the patterned build material layers 102′. The intermediate object 100 is a volume of the build material cake 114 that is filled with the build material particles 104 bound by the precipitated polyfurfuryl alcohol 111. The remainder of the build material cake 114 is made up of non-patterned, and thus unbound, build material particles 104.

In some examples, the build material cake 114, including the intermediate object 100, can be exposed to additional heat in the 3D printing system 10 in order to ensure organic solvent evaporation and polyfurfuryl precipitation. This additional heating process may take place in the printing system 10, as shown in FIG. 1D. The temperature at this heating stage is either the first temperature T₁, or is a temperature between the first temperature T₁ and the second temperature T₂ (used to pyrolyze the precipitated polyfurfuryl alcohol 111). In one example, the additional heating temperature may range from about 70° C. to about 350° C., or from about 100° C. to about 250° C. The additional heating may be performed for a heating time from about 15 minutes to about 4 hours, or from about 20 minutes to about 3 hours, or from about 30 minutes to about 2 hours, or from about 1 hour to about 2 hours.

The intermediate object 100 is then transferred to another heating device, such as an oven, a vacuum tube furnace, or the like for higher temperature heating (described in reference to FIG. 1F).

Prior to the high temperature heating, the 3D printing method may further includes a de-caking step, where the intermediate object 100 is extracted from the build material cake 114. This is shown in FIG. 1E. The intermediate object 100 may be extracted by any suitable means. In an example, the intermediate object 100 is extracted by lifting the intermediate object 100 from the non-patterned portion(s) 110 of the build material cake 114 using an extraction tool. In another example, the intermediate object 100 is extracted using a wet or a dry extraction process. In the example shown in FIG. 1E, the wet extraction process is used to remove the non-patterned portion(s) 110 of the build material cake 114, and thus extract the intermediate object 100. The wet extraction process may include spraying the build material cake 114 with water 30 using a wet extraction tool(s) 28, such as a hose and a sprayer, a spray gun, etc. In other examples, the wet extraction process may include sonicating the build material cake 114 in a water bath or soaking the build material cake 114 in water (or another liquid that will not dissolve the components of the intermediate object 100). In some examples, dry extraction of the non-patterned portion(s) 110 of the build material particles 104 from the build material cake 114 may be used in place of wet extraction. As an example, the non-patterned portion(s) 110 may be removed from the build material cake 114 by suction from a vacuum hose. In this example, the removed build material particles 104 can be collected in a reservoir for future use.

It is to be understood that the build material particles 104 from non-patterned portion(s) 110 that remain bound to the intermediate object 100 after the extraction process may be removed by cleaning with a brush, an air jet, a water jet, or sand blasting.

Referring now to FIG. 1F, the intermediate object 100 is then exposed to higher temperature heating to i) pyrolyze the precipitated polyfurfuryl alcohol 111 and ii) sinter the build material particles 104 of the intermediate object 100 to form the 3D object 116. Thus, after the intermediate object 100 has been generated, the 3D printing method further includes producing a carbon residue from the precipitated polyfurfuryl alcohol 111 and throughout the intermediate object 100 by heating the intermediate object 100 to a second temperature T₂, and sintering the intermediate object 100 to form the 3D object 116.

As noted above, the intermediate object 100 is transferred to another heating device 22′, such as an oven, a vacuum tube furnace, or the like for the higher temperature heating processes.

The higher temperature heating processes may occur gradually over time in the heating device 22′. The intermediate object 100 may be introduced into the heating device 22′, and then the heating device 22′ may be set to the second temperature T₂. The intermediate object 100 can be exposed to the second temperature T₂ for a predetermined time period, and then the heating device 22′ may be set to the third temperature T₃. The intermediate object 100 can then be exposed to the third temperature T₃ for a predetermined time period. During high temperature heating, the intermediate object 100 may be exposed to temperatures between T₂ and T₃ as well.

The high temperature heating processes can be performed in a specific atmosphere or vacuum. In some examples, the specific atmosphere can be an inert gas, a low-reactivity gas, a reducing gas, or a combination thereof. Some gases that can be used in the sintering atmosphere include hydrogen, helium, argon, neon, xenon, krypton, nitrogen, carbon monoxide, and combinations thereof. An inert atmosphere may be desirable when metal or metal alloy build material particles 104 are used to prevent oxidation.

The second temperature T₂ is sufficient to initiate the decomposition (i.e., to pyrolyze) the precipitated polyfurfuryl alcohol 111 and produce the carbon residue. In an example, the second temperature T₂ is above 400° C. It is to be understood that the second temperature T₂ should also be below the melting temperature of the build material particles 104 that are being used. The predetermined time for which the intermediate object 100 is exposed to the second temperature T₂ may range from about 30 minutes to about 4 hours. The predetermined time may depend, in part, upon the second temperature T₂ and the size of the intermediate object 100.

When the precipitated polyfurfuryl alcohol 111 decomposes, the generated carbon residue is present throughout intermediate object 100. The intermediate object 100 can then be exposed to the third temperature T₃. At the third temperature T₃, the carbon residue can act as a carbon dopant, as it can interact or react with the build material particles 104. At the third temperature T₃, the build material particles 104 are also sintered.

The terms “sinter,” “sintered,” “sintering,” or the like refer to the consolidation and physical bonding of the build material particles 104 together (after temporary binding using the binder agent 106) by solid state diffusion bonding, partial melting of the build material particles 104, or a combination of solid state diffusion bonding and partial melting.

Sintering may be accomplished by heating the intermediate object 100 to the third temperature T₃ that is higher than the second temperature T₂ (i.e., T₃>T₂). The third temperature T₃ will depend upon the build material particles 104 that are used, because the third temperature T₃ should be sufficient to sinter the build material particles 104 without exceeding the melting point of the build material particles 104. For metal build material particles, the third temperature T₃ ranges from about 500° C. to about 3500° C. Metal alloy build material particles may have a range of sintering temperatures (due, at least in part, to the different melting temperatures of the various elements that make up the alloy), and thus may be exposed to a third temperature range over the predetermined time period for sintering. In one example, metal alloy build material particles may be expose to multiple temperatures within the range of from about 500° C. to about 3500° C. For ceramic build material particles, the third temperature T₃ ranges from about 500° C. to about 4000° C.

During sintering, the interaction or reaction of the carbon residue with the build material particles 104 will depend upon the material of the build material particles 104. As the build material particles 104 soften, and even partially melt in some cases, the carbon atoms dissolve and diffuse into the build material (e.g., the metal, semi-metal, metal alloy, or ceramic). In instances where metal alloy build material particles 104 are used, particularly steel particles having a carbon content of 0.3% or less (i.e., low-carbon steel), diffusion of the carbon residue occurs at the eutectoid point of the metal alloy. At this point, the carbon residue diffused into metal alloy induces a phase change of the metal alloy from the soft ferrite crystal structure (which has an interlocking network of positively-charged metal ions and negatively-charged oxygen ions) to the harder pearlite structure (which has alternating layers of ferrite and cementite). It should be understood that the amount of pearlite depends on the amount of carbon residue that diffuses, which can be controlled by the heating process (described below). In an example, the pearlite microstructure of the resulting 3D object 116 increases with increasing carbon content diffused in the softened, and in some instances partially melted, alloy. With a higher pearlite content, the 3D object 116 exhibits superior material properties, at least in terms of the toughness and ductility, compared to a 3D object 116 in its ferrite form.

As mentioned, carbon diffusion can be controlled during the high temperature heating process, which may be used to achieve site-specific carbon doping of the build material. Site-specific doping may be advantageous to achieve specific or desired mechanical properties at one or more sites or locations in the final 3D object, such as increased hardness at certain sites of the 3D object or increased elasticity at other sites of the 3D object. Site-specific doping may be achieved using spark plasma sintering rather than pressure-less sintering to minimize the diffusion of carbon at certain sites or locations. Another way to achieve site-specific doping is to introduce a smaller amount of binder agent 106 to predetermined sites that are to be carbon deficient and a larger amount of binder agent 106 to predetermined sites that are to be carbon rich.

As described, when the carbon residue diffuses into the coalesced build material of the 3D object 116, the carbon residue alloys or dopes the 3D object 116. It should also be understood that the carbon residue diffuses (or spreads) into the matrix of the coalesced build material. Therefore, the carbon residue may become distributed throughout the entire object 116, including within the body of the object 116 as well as at the surface(s) of the object 116. The carbon residue may be evenly distributed throughout the 3D object 116.

Once the intermediate object 100 has been sintered and the 3D object 116 has been formed, the 3D printing method further includes cooling the 3D object 116 at a predetermined cooling rate. The cooling rate may be controlled to control the amount of the dissolved/diffused carbon will segregate into carbide. Slow cooling leads to more pearlite (alternating strips of ferrite and cementite, which is iron carbide). Pearlite is more ductile and less strong than martensite or bainite. Fast cooling leads to no carbide segregation, i.e., martensite formation, which is brittle and strong. In instances where more carbide is formed, the 3D object may have less mechanical strength and exhibit a stretch-like property. In instances where less carbide is formed, the 3D object will have high mechanical strength but may become brittle, similar to a ceramic. Either instance can be desirable depending on the end use of the 3D object 116. When more carbide is desirable, the predetermined cooling rate may be about 0.01° C./s. When no carbide is desirable, the predetermined cooling rate may be about 700° C./s. Ranges in between may be used to adjust the amount of carbide that is formed. Cooling may be accomplished passively, by allowing the temperature of the 3D object 116 to reduce naturally. This leads to some carbide formation. Alternatively, cooling may be accomplished actively, by exposing the 3D object 116 to water quenching, oil quenching, or cool/cold air.

The final 3D object 116 is formed once cooling is complete.

### 3D Printing Kit

Examples of the build material composition and the binder agent 106 described above may be part of a 3D printing kit. This example 3D printing kit includes the build material composition with the metal, semi-metal, metal alloy, and/or ceramic build material particles 104, and the binder agent 106 consisting of an organic solvent and polyfurfuryl alcohol dissolved in the organic solvent, where the binder agent 106 is free of solids. Details of the build material composition and the binder agent 106 are provided above. When the 3D printing kit includes ceramic build material particles 104, the kit may also include a coloring agent, which is described in more detail in the section “Other Implementations.”

It should be understood that the binder fluid 106 and the build material composition of the 3D printing kit may be maintained separately until used together in the 3D printing method of Implementation 1. The binder fluid 106 and/or build material composition may each be contained in one or more containers prior to and during printing, but may be combined together during printing. The containers can be any type of vessel (e.g., reservoir, box, or receptacle) made of any material.

### Implementation 2

In Implementation 2, the 3D printing method uses polymeric build material particles to generate a polymer 3D object.

### Binder Agent

The binder agent 106 for the 3D printing method of Implementation 2 is the same as described herein for Implementation 1. It is noted that although the binder agent 106 possesses both binding and doping capabilities, the binder agent operates solely to bind the polymeric build material particles in Implementation 2 because the high temperature heating of Implementation 1 is not utilized.

### Build Material

The build material for the 3D printing method of Implementation 2 includes polymeric build material particles.

The polymeric build material particles may be any polymeric material that is capable of being 3D printed and impart desired properties (e.g., bendability, strength, etc.) to the final 3D part. Examples of suitable polymeric materials include a polyamide (PA), (e.g., PA 11/nylon 11, PA 12/nylon 12, PA 6/nylon 6, PA 8/nylon 8, PA 9/nylon 9, PA 66/nylon 66, PA 612/nylon 612, PA 812/nylon 812, PA 912/nylon 912, etc.), a thermoplastic polyamide (TPA), a thermoplastic polyurethane (TPU), polyethylene terephthalate, polybutylene terephthalate, polystyrene, polypropylene, high density polyethylene, polyetherketone, polyether ether ketone (PEEK), polyetherketoneketone, epoxies, phenolic resins, and/or combinations thereof. When the 3D part is to be bendable, any of the thermoplastic polymeric materials may be selected for the build material.

The polymeric build material particles may be made up of similarly sized particles and/or differently sized particles. In an example, the average particle size of the polymeric build material particles ranges from about 2 μm to about 225 μm. In another example, the average particle size of the polymeric build material particles ranges from about 10 μm to about 130 μm. In an example, the particle sizes within a particle distribution of polymeric build material particles ranges from about 30 μm to about 125 μm with a median diameter (D50) of about 60 μm.

In an example, the polymeric build material particles may be in the form of a powder. In another example, the polymeric build material particles may be in the form of a powder-like material, which includes, for example, short fibers having a length that is greater than its width. In some examples, the powder or powder-like material may be formed from, or may include, short fibers that may, for example, have been cut into short lengths from long strands or threads of material. For both powder and powder-like materials, the polymeric build material may also be referred to herein as a dry or solid build material.

The polymeric build material particles are part of a build material composition used to form the build material layer in the 3D printing method of Implementation 2. In some instances, the build material composition consists of the polymeric build material particles. In other instances, the polymeric build material particles are included in the build material composition with other additives. In an example, the build material includes from about 80 wt % to 100 wt % of the polymeric build material particles, based on the total weight of the build material composition. In other examples, the build material composition includes the polymeric build material particles present in amounts ranging from about 90 wt % to 100 wt %, or from about 95 wt % to 100 wt %, or in an amount of 100 wt %, all based on the total weight of the build material composition. When the build material composition is made up entirely of the polymeric build material particles, the polymeric build material particles account for 100% of the composition. When the polymeric build material particles are present in the build material composition in an amount of less than 100 wt %, the remainder of the build material composition may be made up of additives. In Examples of suitable additives may include an antioxidant, a whitener, an antistatic agent, a flow aid, and/or combinations thereof. While several examples of these additives are provided, it is to be understood that these additives are selected to be thermally stable (i.e., will not decompose) at the 3D printing temperatures used for the polymeric build material particles.

Antioxidant(s) may be added to the build material composition to prevent or slow molecular weight decreases of the polymeric build material particles and/or may prevent or slow discoloration (e.g., yellowing) of the polymeric build material particles by preventing or slowing oxidation of the polymeric build material particles. In some examples, the polymeric build material particles may discolor upon reacting with oxygen, and this discoloration may contribute to the discoloration of the build material. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material. In an example, the antioxidant may be included in the build material in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process of Implementation 2 may be selected so that the stilbene derivative remains stable (i.e., the 3D printing temperature does not thermally decompose the stilbene derivative). In an example, any example of the whitener may be included in the build material in an amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the build material composition.

Flow aid(s) may be added to improve the coating flowability of the build material composition during layer formation. The same examples of the flow aid that may be included in the metal, semi-metal, metal alloy, or ceramic based build material composition of Implementation 1 may be included in the polymeric based build material composition of Implementation 2. In an example, the flow aid is added in an amount ranging from greater than 0 wt % to less than 5 wt %, based upon the total weight of the build material.

### Detailing Agent

As will be described in more detail below, the 3D printing method of Implementation 2 involves the selective application of a detailing agent. The detailing agent does not include dissolved polyfurfuryl alcohol, and may be applied to portion(s) of the build material composition that is/are outside of an area based on the 3D digital model used for forming the 3D printed object. The portion(s) of the build material composition exposed to the detailing agent may experience a cooling effect, and thus the detailing agent helps to keep the portion(s) from coalescing.

The detailing agent may include a surfactant, a co-solvent, and a balance of water. In some examples, the detailing agent consists of these components, and no other components. In other examples, the detailing agent may further include additional components, such as anti-kogation agent(s), antimicrobial agent(s), and/or chelating agent(s).

The surfactant(s) that may be used in the detailing agent include non-ionic or anionic surfactants. Some example surfactants include alcohol ethoxylates, alcohol ethoxysulfates, acetylenic diols, alkyl polyethylene oxides, alkyl phenyl polyethylene oxides, polyethylene oxide block copolymers, acetylenic polyethylene oxides, polyethylene oxide (di) esters, polyethylene oxide amines, protonated polyethylene oxide amines, protonated polyethylene oxide amides, dimethicone copolyols, substituted amine oxides, fluorosurfactants, and the like. Some specific examples of non-ionic surfactants include the following from Evonik Degussa: SURFYNOL® SEF (a self-emulsifiable, wetting agent based on acetylenic diol chemistry), SURFYNOL® 440 or SURFYNOL® CT-111 (non-ionic ethoxylated low-foam wetting agents), SURFYNOL® 420 (non-ionic ethoxylated wetting agent and molecular defoamer), SURFYNOL® 104E (non-ionic wetting agents and molecular defoamer), and TEGO® Wet 510 (organic surfactant). Other specific examples of non-ionic surfactants include the following from The Dow Chemical Company: TERGITOL™ TMN-6, TERGITOL™ 15-S-7, TERGITOL™ 15-S-9, TERGITOL™ 15-S-12 (secondary alcohol ethoxylates). Other suitable non-ionic surfactants are available from Chemours, including the CAPSTONE® fluorosurfactants, such as CAPSTONE® FS-35 (a non-ionic fluorosurfactant). Some specific examples of anionic surfactants include alkyldiphenyloxide disulfonate (e.g., the DOWFAX™ series, such a 2A1, 3B2, 8390, C6L, C10L, and 30599, from The Dow Chemical Company), docusate sodium (i.e., dioctyl sodium sulfosuccinate), sodium dodecyl sulfate (SDS). The total amount of surfactant(s) in the detailing agent may range from about 0.10 wt % active to about 5.00 wt % active with respect to the total weight of the detailing agent.

The co-solvent(s) that may be used in the detailing agent include water soluble or water miscible organic co-solvents, such as aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols (e.g., 1,2-ethanediol, 1,2-propanediol, etc.), 1,3-alcohols (e.g., 1,3-propanediol), 1,5-alcohols (e.g., 1,5-pentanediol), 1,6-hexanediol or other diols (e.g., 2-methyl-1,3-propanediol, etc.), ethylene glycol alkyl ethers, propylene glycol, propylene glycol alkyl ethers, higher homologs (C₆-C₁₂) of polyethylene glycol alkyl ethers, diethylene glycol, triethylene glycol, tripropylene glycol methyl ether, tetraethylene glycol, glycerol, N-alkyl caprolactams, unsubstituted caprolactams, 2-pyrrolidone, 1-methyl-2-pyrrolidone, 1-(2-hydroxyethyl)-2-pyrrolidone (also known as N-(2-hydroxyethyl)-2-pyrrolidinone (HEP)), and the like. Other examples of organic co-solvents include dimethyl sulfoxide (DMSO), isopropyl alcohol, ethanol, pentanol, acetone, or the like. The total amount of co-solvent(s) in the detailing agent may range from about 1 wt % active to about 65 wt % active with respect to the total weight of the detailing agent.

The detailing agent may also include anti-kogation agent(s) when it is to be jetted using thermal inkjet printing. Kogation refers to the deposit of dried printing liquid on a heating element of a thermal inkjet printhead. Anti-kogation agent(s) is/are included to assist in preventing the buildup of kogation. Examples of suitable anti-kogation agents include oleth-3-phosphate (commercially available as CRODAFOS™ O3A or CRODAFOS™ N-3A) or dextran 500k. Other suitable examples of the anti-kogation agents include CRODAFOST HCE (phosphate-ester from Croda Int.), CRODAFOS® 010A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used. The anti-kogation agent may be present in the detailing agent in an amount of from about 0.1 wt % active to about 1.5 wt % active, based on the total weight of the detailing agent. In an example, the anti-kogation agent is present in an amount of about 0.5 wt % active, based on the total weight of the detailing agent.

The detailing agent may also include antimicrobial agent(s). Antimicrobial agents are also known as biocides and/or fungicides. Examples of suitable antimicrobial agents include the NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof. In an example, the total amount of antimicrobial agent(s) in the detailing agent is from about 0.01 wt % active to about 0.05 wt % active, based on the total weight of the detailing agent. In another example, the total amount of antimicrobial agent(s) in the fusing agent is about 0.04 wt % active, based on the total weight of the detailing agent.

Chelating agents (or sequestering agents) may be included in the detailing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals. Whether a single chelating agent is used or a combination of chelating agents is used, the total amount of chelating agent(s) in the detailing agent may range from greater than 0 wt % active to about 0.5 wt % active, based on the total weight of the detailing agent. In an example, the chelating agent is present in an amount of from about 0.05 wt % active to about 0.2 wt % active, based on the total weight of detailing agent. In another example, the chelating agent(s) is/are present in the detailing agent in an amount of about 0.05 wt % active, based on the total weight of the detailing agent.

The balance of the detailing agent is water. As such, the amount of water may vary depending upon the amounts of the other components that are included.

### 3D Printing Method

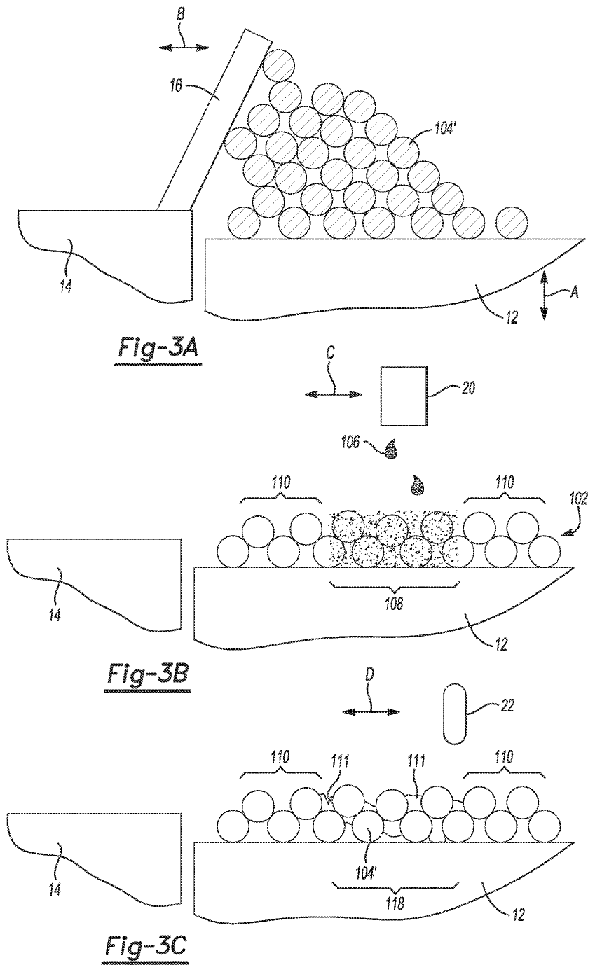

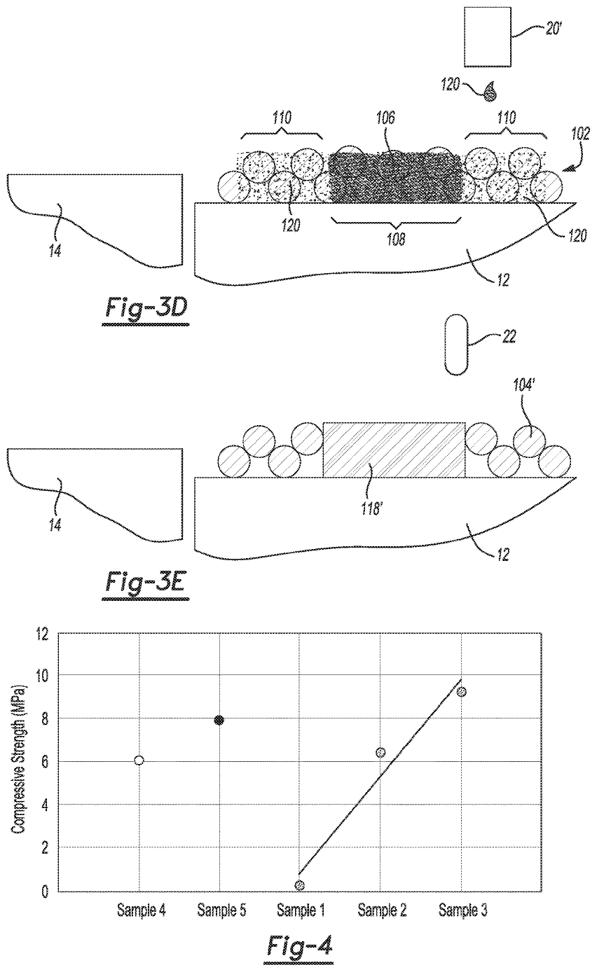

Examples of the 3D printing method utilizing the polymeric build material particles and the binder agent is described below with reference to FIG. 3A through FIG. 3E. One example method is shown in FIG. 3A through FIG. 3C, and another example method is shown in FIG. 3A, FIG. 3B, FIG. 3D, and FIG. 3E. The 3D printing system 10 of FIG. 2 may be used in these example methods, and thus the specific components of the 3D printing system 10 are not described again in reference to Implementation 2.

One example 3D printing method of Implementation 2 comprises forming a build material layer with polymeric build material particles (FIG. 3A), based on data derived from a digital 3D object model, selectively applying a binder agent to at least a portion of the build material layer, the binder agent being free of solids and consisting of an organic solvent and polyfurfuryl alcohol dissolved in the organic solvent (FIG. 3B), and evaporating the organic solvent and precipitating the polyfurfuryl alcohol out of solution by heating the build material layer, thereby binding the polymeric build material particles in the at least the portion of the build material layer with precipitated polyfurfuryl alcohol (FIG. 3C).

Another example 3D printing method of Implementation 2 comprises forming a build material layer with polymeric build material particles (FIG. 3A), based on data derived from a digital 3D object model, selectively applying a binder agent to at least a portion of the build material layer, the binder agent being free of solids and consisting of an organic solvent and polyfurfuryl alcohol dissolved in the organic solvent (FIG. 3B), based on data derived from a digital 3D object model, selectively applying a detailing agent to at least another portion of the build material layer (FIG. 3D), and heating the build material layer, thereby forming a coalesced 3D object layer at the at least the portion (FIG. 3E).

Throughout FIG. 3A through FIG. 3E, the polymeric build material particles are represented by reference numeral 104′.

In FIG. 3A, the build area platform 12 or a previously formed layer 118 or 118′ receives the polymeric build material particles 104′ from the build material supply 14, and the build material distributor 16 pushes or otherwise spreads the polymeric build material particles 104′ onto the build area platform 12 to form a substantially uniform build material layer 102 thereon. The formation of the build material layer 102 may be performed as described in Implementation 1.

In FIG. 3B, the binding agent 106 is selectively applied to the portion(s) 108 of the build material layer 102. In some instances, other portion(s) 110 remain free of the binding agent 106 as these portion(s) 110 are not to be become part of the final 3D object layer. The selective application of the binding agent 106 may be performed as described in Implementation 1. Similar to Implementation 1, the organic solvent of the binder agent 106 is capable of wetting the build material particles 104′ of the build material layer 102, and penetrating into the microscopic pores/voids of the build material layer 102 (i.e., spaces between the build material particles 104′). The polyfurfuryl alcohol, which precipitates out of solution during solvent evaporation, will then exist in these microscopic pores/voids to hold the materials particles 104′ together.

In FIG. 3C, the organic solvent of the binding agent 106 is evaporated and the polyfurfuryl alcohol of the binding agent 106 is precipitated out of solution by heating the build material layer 102. In this example, the heating temperature is selected to be below the melting point of the polymeric build material particles 104′ and high enough to achieve organic solvent evaporation and polyfurfuryl alcohol precipitation. As such, the temperature will depend upon the organic solvent and the polymeric build material particles 104′ that are used. It is to be understood that the temperature at which the organic solvent evaporates should not be higher than the melting temperature(s) of the polymeric build material particles 104′, that way the polyfurfuryl alcohol precipitate 111 can be formed without melting the polymeric build material particles 104′. It is to be understood that the heating temperature should be less than 400° C. so that the precipitated polyfurfuryl alcohol 111 does not pyrolyze. As an example, the heating temperature ranges from about 50° C. to about 150° C. As another example, the heating temperature is less than 100° C.

Heating may be accomplished using the heater 22 as described in reference to FIG. 1C. While application of the binder agent 106 and heating are shown in separate figures, it is to be understood that heating takes place as the binder agent 106 is applied to the individual layers 102. In these examples, the build material platform 12 is maintained at the desired temperature while the binding agent 106 is applied to the portion(s) 108. As described in reference to Implementation 1, the printing system 10 can sense the then-current temperature and increase the temperature before printing begins. In other examples, the binder agent 106 is applied and then the layer 102 is heated.

As shown in FIG. 3C, heating forms the precipitated polyfurfuryl alcohol 111. The precipitated polyfurfuryl alcohol 111 is sticky, and thus is able to hold adjacent polymeric build material particles 104′ together wherever the binding agent 106 had been deposited. In this example method, this forms one layer 118 of the 3D object that is being formed.

This example 3D printing method further includes repeating the forming, the selectively applying, and the heating steps, which generates the polymeric 3D object held together with the precipitated polyfurfuryl alcohol 111. In essence, the method steps described above in connection with FIGS. 3A through 3C are repeated to iteratively build up several layers 118 to form one example of the polymeric 3D object. In particular, the method includes repeating the forming of the build material layer 102 with the build material particles 104′, the selectively applying of the binder agent 106, and the heating of the layer 102 (with the binder agent 106 thereon). The processes may be repeated once, twice, or several times to generate the polymeric 3D object, and the number of times depends upon the 3D object model being used.

In the method depicted in FIG. 3A, FIG. 3B, FIG. 3D, and FIG. 3E, the formation of the build material layer 102 (with the polymeric build material particles 104′) and the selective application of the binder agent 106 may be performed as described herein.

Referring now to FIG. 3D, the detailing agent 120 is applied to the portion(s) 110 of the layer 102 that is/are not to become part of the polymeric 3D object. The detailing agent 120 may be dispensed from an applicator 20′. The applicator 20′ may be separate from the applicator 20, or may be a separate compartment within the applicator 20. In either instance, the applicator 20′ includes its own printhead (e.g., thermal, piezoelectric, or continuous). As such, the selective application of the detailing agent 120 may be accomplished by thermal inkjet printing, piezo electric inkjet printing, continuous inkjet printing, etc. The controller 18 may process data, and in response, control the applicator 20′ to deposit the detailing agent 120 onto the portion(s) 110 of the build material layer 102.

The addition of the detailing agent 120 to the portion(s) 110 provides a cooling effect so that during subsequent heating, the polymeric build material particles 104′ in the portion(s) 110 do not coalesce. During heating, the detailing agent 120 is able to keep the polymeric build material particles 104′ from reaching their melting temperature. Thus, coalescence of the polymeric build material particles 104′ in the portion(s) 110 is prevented.

While not shown in FIG. 3D, it is to be understood that if heating is performed while the binder agent 106 is applied (FIG. 3C), the precipitated polyfurfuryl alcohol 111 may be present in the portion(s) 108.

Once the binding agent 106 and the detailing agent 120 are selectively applied, the layer 102 is exposed to heating (FIG. 3E). This heating process may be accomplished using the heater 22 as described in reference to FIG. 1C.

At this stage, the heating temperature is sufficient to initiate melting of the polymeric build material particles 104′ in the portion(s) 108. As such, the heating temperature depends upon the polymeric build material particles 104′ that are used. During heating, these melting particles 104′ are able to coalesce (e.g., thermally merge, melt together, or otherwise bind together as a result of softening). In contrast, the polymeric build material particles 104′ in the portion(s) 110 are cooled by the detailing agent 120, and thus do not begin to melt.

If the polyfurfuryl alcohol had not already precipitated out of solution as a result of heating during binder agent 106 application, this heating process will generate the polyfurfuryl alcohol precipitate 111. Depending upon the heating temperature, this process may also convert the polyfurfuryl alcohol precipitate 111 to the carbon residue. Few polymeric build material particles 104′ (e.g., PEEK, epoxies, phenolic resins) can withstand heating above 400° C., so the carbon residue is rarely generated in this example method.

This example method forms one layer 118′ of the polymeric 3D object that includes coalesced build material and either polyfurfuryl alcohol precipitate 111 or carbon residue intermingled throughout the coalesced build material.

This example of the 3D printing method further includes repeating the forming, the selectively applying of the binding agent 106 and the detailing agent 120, and the heating steps, which generates the polymeric 3D object with coalesced polymer build material. In essence, the method steps described above in connection with FIGS. 3A, 3B, 3D and 3E are repeated to iteratively build up several layers 118′ to form another example of the polymeric 3D object. In particular, the method includes repeating the forming of the build material layer 102 with the build material particles 104′, the selectively applying of the binder agent 106, the selectively applying of the detailing agent 120, and the heating of the layer 102 (with the binder agent 106 and detailing agent 120 thereon). The processes may be repeated once, twice, or several times to generate the polymeric 3D object, and the number of times depends upon the 3D object model being used.

### 3D Printing Kit

Examples of the polymeric based build material composition and the binder agent 106 may be part of a 3D printing kit. This example 3D printing kit includes the build material composition with the polymeric build material particles 104′, and the binder agent 106 consisting of an organic solvent and polyfurfuryl alcohol dissolved in the organic solvent, where the binder agent 106 is free of solids. Details of the build material composition and the binder agent 106 are provided above.

In an example, the 3D printing kit is referred to as a single binder agent kit that includes the polymeric build material composition (which is a dry or solid component) and the single binder agent 106. Alternatively, the 3D printing kit could be a multi-fluid kit, which includes the polymeric build material composition, the binder agent 106, and the detailing agent 120. In some instances, the multi-fluid kit may also include the coloring agent described herein.

It should be understood that the fluid(s) 106 or 106 and 120 and the build material composition of the 3D printing kit may be maintained separately until used together in the 3D printing method of Implementation 2. The fluid(s) 106 or 106 and 120 and/or build material composition may each be contained in one or more containers prior to and during printing, but may be combined together during printing. The containers can be any type of vessel (e.g., reservoir, box, or receptacle) made of any material.

### OTHER IMPLEMENTATIONS

The binder agent 106 may also be used in other 3D additive manufacturing processes, such as press casting or injection molding. In these processes, the binder agent 106 can be mixed with the build material particles and exposed to the desired process (casting or molding) and then heated. The binder agent 106 behaves similarly as described herein, where the solvent is evaporated and the precipitated polyfurfuryl alcohol 111 acts as a binder for the build material.

The binder agent 106 may also be used for post treating a 3D object manufactured using a 3D additive manufacturing process. In this example, any metal, semi-metal, metal alloy, or ceramic 3D manufactured object may be dipped into the binder agent 106 followed by the high temperature heating processes disclosed herein. This process will carbonize the surface of the metal, semi-metal, metal alloy, or ceramic 3D manufactured object.

In either Implementation 1 (when performed with ceramic build material) or Implementation 2, a coloring agent may be used in the 3D printing methods to impart color to the 3D object that is formed. The coloring agent can be selectively applied in the same manner as the binder agent 106 (e.g., via inkjet printing), and can be added to the build material particles 104, 104′ during printing or can be added to the exterior of the ceramic or polymeric 3D object after it is formed.

The coloring agent may include a colorant (i.e., pigment and/or dye), a co-solvent, and a balance of water. In some examples, the coloring agent consists of these components, and no other components. In some other examples, the coloring agent may further include a binder (e.g., an acrylic latex binder, which may be a copolymer of any two or more of styrene, acrylic acid, methacrylic acid, methyl methacrylate, ethyl methacrylate, and butyl methacrylate) and/or a buffer. In still other examples, the coloring agent may further include additional components, such as dispersant(s), humectant(s), non-ionic or anionic surfactant(s), polymeric binder(s), anti-kogation agent(s), antimicrobial agent(s), and/or chelating agent(s) (several of which are described herein in reference to the detailing agent).

The coloring agent may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color.

An example of the pigment based coloring agent may include from about 1 wt % to about 10 wt % of pigment(s), from about 10 wt % to about 30 wt % of co-solvent(s), from about 1 wt % to about 10 wt % of dispersant(s), from about 0.1 wt % to about 5 wt % of binder(s), from 0.01 wt % to about 1 wt % of anti-kogation agent(s), from about 0.05 wt % to about 0.1 wt % antimicrobial agent(s), and a balance of water. An example of the dye based coloring agent may include from about 1 wt % to about 7 wt % of dye(s), from about 10 wt % to about 30 wt % of co-solvent(s), from about 1 wt % to about 7 wt % of dispersant(s), from about 0.05 wt % to about 0.1 wt % antimicrobial agent(s), from 0.05 wt % to about 0.1 wt % of chelating agent(s), from about 0.005 wt % to about 0.2 wt % of buffer(s), and a balance of water.

Some examples of the coloring agent include a set of cyan, magenta, and yellow agents, such as C1893A (cyan), C1984A (magenta), and C1985A (yellow); or C4801A (cyan), C4802A (magenta), and C4803A (yellow); all of which are available from HP Inc. Other commercially available coloring agents 18 include C9384A (printhead HP 72), C9383A (printhead HP 72), C4901A (printhead HP 940), and C4900A (printhead HP 940).

To further illustrate the present disclosure, an example is given herein. It is to be understood that this example is provided for illustrative purposes and is not to be construed as limiting the scope of the present disclosure.

### Example

### Build Material

A custom-made manganese (Mn) steel powder was used for each of the Examples described below. The composition of the Mn steel powder was 0.11 wt % carbon (C), 1.5 wt % manganese (Mn), less than 0.05 wt % silicon (Si), 0.5 wt % molybdenum (Mo), and the balance iron (Fe). The average particle size was less than 22 micrometers (μm).

### Binder Agent

A binder agent containing polyfurfuryl alcohol dissolved in acetone was prepared as follows. Furfuryl alcohol (≥97%, obtained from Sigma Aldrich) was polymerized using sulfuric acid as an acid catalyst. At a ratio of 1:33, 1.8M sulfuric acid was added to a batch of furfuryl alcohol dropwise while mixing with a magnetic stirrer and heating at 50° C. on a magnetic hot plate stirrer. This mixture was a strong acidic solution. An exothermic reaction took place at about 7 minutes from the start of the polymerization reaction, as evidenced by a brief, but vigorous, boiling of the solution. In addition, by visual inspection, the solution appeared to increase in viscosity and the color changed from a yellow color to a dark brown color. To prevent damage to the printhead of the 3D printing system by the strong acidic solution, 40 microliters (μL) of a 10M sodium hydroxide solution was added to the furfuryl alcohol-sulfuric acid solution for neutralization after 30 seconds of boiling.

Once the reaction was complete, as evidenced by the dark brown color of the solution, the solution was centrifuged at 5000 rpm for 10 minutes to separate out the water, which formed as a by-product of neutralization. Afterwards, the polyfurfuryl alcohol was incubated in an oven at 50° C. for 2 hours to ensure that all of the water had been removed. Viscous polyfurfuryl alcohol resin remained after incubation. The state of the viscous polyfurfuryl alcohol resin was between an oil and a fat (e.g., similar to softened butter).

The polyfurfuryl alcohol was then dissolved in acetone and left overnight to ensure that the polymer was fully dissolved. Centrifuging and filtering with grade 1 filter paper were used to remove all undissolved polyfurfuryl particles. The resultant particle-free binder agent, including the polyfurfuryl alcohol dissolved in acetone, was used in the following tests.

### Printing and Post-Processing of Final 3D Objects

A 3D printing system obtained from HP Inc. was utilized as a binder jetting testbed. The 3D printing system included several thermal inkjet printheads, each of which contained 2112 nozzles. The nozzle diameter was about 20 μm.

The binder agent was filled into several thermal inkjet printheads/cartridges, which were installed into the 3D printing system. The Mn-steel powder was loaded into a supply bed of the system. The 3D printing system further included an automated roller to spread a 0.05 mm thick layer of the Mn-steel powder for each layer on a print bed. The Mn-steel powder in both the supply bed and the print bed were incubated at 45° C. throughout the binder jetting/printing process.

Five samples of 3D objects were formed using the binder jetting process. For each sample, layers of build material were patterned with a binder agent, which was inkjet printed on each layer according to a 3D object model. In samples 1-3 (example samples), the particle-free polyfurfuryl alcohol solution described in this Example was used as the binder agent. Different amounts of the binder agent were applied to achieve different weight percentages of carbon in samples 1-3. In sample 4 (a comparative sample), a latex-based binder agent was used. In sample 5 (a comparative sample), a carbon ink made by adding carbon nanoparticles into the latex-based binder agent was used.

Once printing was complete, the temperature was increased to 100° C. and the printed objects were incubated for 30 minutes to dry the binder agent and generate the intermediate object (i.e., a green body). Five green bodies were generated. Afterwards, the green bodies of samples 1-5 were transferred to a crucible and heated in a vacuum tube furnace to form 3D objects. This is referred to as pressure-less sintering. The heating profile (which ultimately sinters the green body to form the 3D object) included heating at 450° C. for 3 hours, then increasing the temperature to 900° C. (at a rate of 5° C./min) and then heating at 900° C. for 2 hours, and then increasing the temperature to 1300° C. (at a rate of 3.3° C./min) and then heating at 1300° C. for 3 hours.

### Binder Characterization

Some of the binder agent containing polyfurfuryl alcohol was exposed to thermogravimetric analysis to measure the final carbon content of the binder when heated at high temperatures. A TGA Q500 thermogravimetric analyzer was used. The heating profile was increased from 25° C. to 900° C. in a nitrogen atmosphere at a rate of 5° C. per minute. While not reproduced herein, the results indicated that 1.312 wt % of carbon was left after heating to 900° C. This equated to 0.98 mg of carbon for 16.09 mg of binder. These results indicate that the PFA binder agent is viable source for carbon.

### Carbon Content

The carbon content of each of the five 3D objects (samples 1-5) were determined using a combustion test provided by an IMR test lab using an infrared detector. The carbon content of samples 1-5 are summarized in Table 1 below, and was uniform across each of the samples.

TABLE 1
Carbon Content of Samples 1-5

| Sample | Carbon Content (wt %) |
|---|---|
| 1 | 0.12 |
| 2 | 0.25 |
| 3 | 0.45 |
| 4 | 0 |
| 5 | 0.49 |

### Compression Test

A compression test was performed to measure the compressive strength (MPa) of the green bodies of each of the samples 1-5. Cube shaped samples were generated from samples 1-5 according to ASTM C109 standard. The cube was place in between two compression plates and was compressed quasistatically at a compressive strain rate of 0.01 mm/s. The applied load was recorded and stress was calculated by dividing the load applied over sample's area. The compression test was performed using a Shimadzu Autograph AGS-X machine using a 10 kN load cell and a compressive strain rate of 0.01 mm/s. Notably, the compression test was performed rather than a tensile test, because the green bodies were not strong enough to be secured to the tensile grips.

The results of the compression test of samples 1-5 are summarized in the graph of compressive strength (MPa) depicted in FIG. 4. The results show that the green body formed using the carbon ink (sample 5) has a higher compressive strength compared to the commercial polymer latex binder (sample 4). This is because the carbon nanoparticles of the carbon ink filled gaps between adjacent build material particles of the green body of sample 5, thereby increasing the overall packing density of the green body of sample 5.

The compressive strength of the green bodies formed using the binder agent including the polyfurfuryl alcohol binder increased with increased precipitated polyfurfuryl alcohol concentration. Because the carbon in the final 3D objects is partially generated from pyrolyzed polyfurfuryl alcohol, the conclusion was drawn that the precipitated polyfurfuryl alcohol concentration increased from the green body of sample 1 to the green body of sample 2 to the green body of sample 3. The compressive strength of the green body of sample 1, the corresponding 3D object of which contained 0.12 wt % carbon, was about 0.1 MPa. The compressive strength increased to about 6.2 MPa for the green body of sample 2, the corresponding 3D object of which had a carbon content of 0.25 wt %. The compressive strength increased yet again to about 9.5 MPa for the green body of sample 3, the corresponding 3D object of which has a carbon content of 0.45 wt %. The increased carbon content from sample 1 to sample 3 indicated an increase in precipitated polyfurfuryl alcohol content from sample 1 to sample. The increased binder content led to an increase in surface area which created greater adhesion between build material layers of the green body.

Notably, sample 5, which was formed using the carbon ink, had a similar carbon content (0.49 wt % carbon content) as sample 3 which was formed using the polyfurfuryl alcohol binder agent (0.45 wt % carbon content). However, the green body of sample 3 unexpectedly had better compressive strength (9.5 MPa) compared to the compressive strength (8 MPa) of the green body of sample 5. This may be due to the stickiness of the precipitated polyfurfuryl alcohol and/or the lack of stickiness of the carbon nanoparticles.

### Bending Test

A bending test was performed to measure the bending strength of the green bodies of each of the samples 1-5. The bending test was performed using a TA Q800 dynamic mechanical analyzer (DMA) available from Texas Instruments in accordance with the manufacturer instructions.

Each of the green bodies of samples 1-5 was tested using three-point bending at a fixed temperature of 25° C., an amplitude of 5 μm, and a frequency sweeping from 1 Hz to 100 Hz. The 3-Point bending test was performed where the sample was placed in a holder and secured by two fixed clamps at near both end of the sample, with another moveable clamp positioned at the center of the sample. When the test started, the center moveable clamp was moved up and down, hitting the sample at a pre-set frequency and amplitude. The test was stopped when the run was completed or the sample was fractured.

The results of the bending test are summarized in the graph depicted in FIG. 5, which is a line graph showing the storage modulus (MPa) versus the frequency (Hz) of samples 3-5. The graph shows that the green body formed using the commercial polymer latex binder (sample 4) demonstrated good elasticity with a storage modulus of about 8000 MPa, while the green body formed using the carbon ink (sample 5) had a much lower storage modulus of 2850 MPa, demonstrating less elasticity compared to the green body of sample 4. The lower storage modulus may be due, at least in part, to energy dissipation that occurs during bending to overcome the carbon particles (of the carbon ink) located within the green body. Notably, the green body of sample 5 also fractured when the amplitude was increased to 10 μm and 15 μm.

The green body formed using the polyfurfuryl alcohol binder (0.45 wt % carbon content) of sample 3 exhibited a higher storage modulus of 3360 MPa compared to the green body formed using the carbon ink (sample 5). Again, the carbon content in each of these binders is similar. The higher storage modulus of the green body of sample 3 indicated that the green body was more elastic compared to the green body of sample 5. This result is due, at least in part, to less energy dissipation occurring during bending because of the absence of particles in the polyfurfuryl alcohol binder. However, the green body of sample 3 was not as mechanically strong as the green body formed using the commercial polymer latex binder (sample 4). This may be because the binding ability of the polyfurfuryl alcohol binder comes from the stickiness of the polyfurfuryl alcohol while the binding ability of the polymer latex binder comes from the curing process.

### Mechanical Property of Sintered 3D Objects

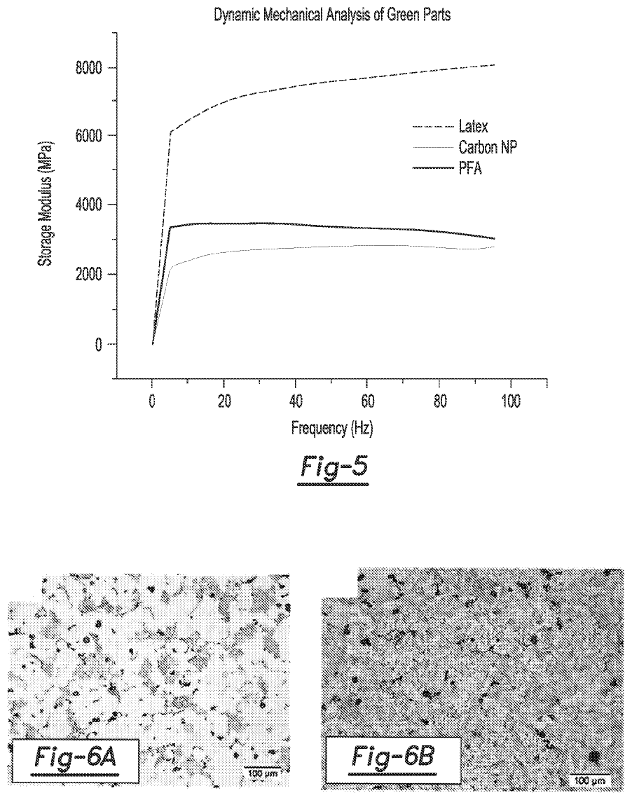

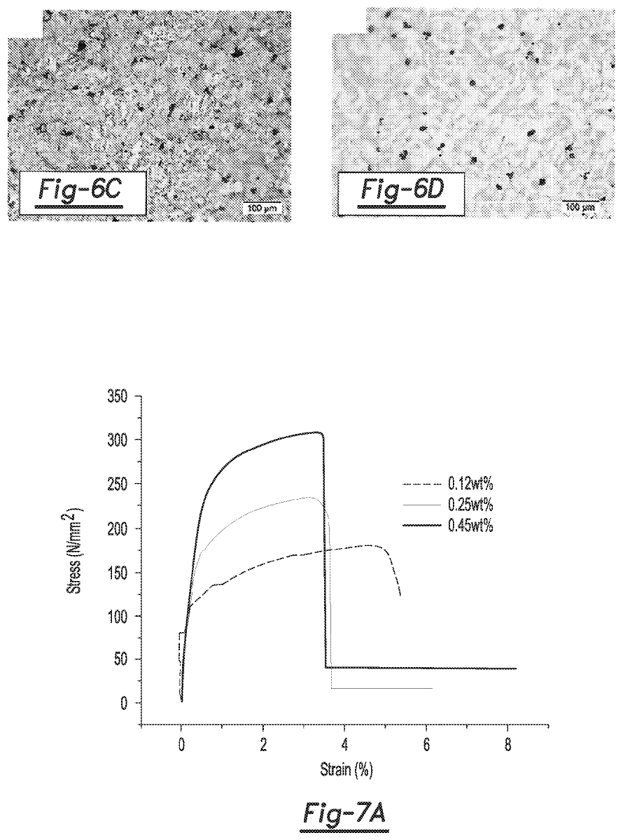

The green bodies of samples 1-3 were heated as described in this Example and images of the microstructure of each of the 3D objects were captured using optical microscopy. These images are shown in the FIG. 6 series. FIG. 6A is an image (reproduced in black and white) of the sample 1, which included 0.12 wt % of carbon dopant. FIG. 6B is an image (reproduced in black and white) of the sample 2, which included 0.25 wt % of carbon dopant. FIG. 6C is an image (reproduced in black and white) of the sample 3, which included 0.45 wt % of carbon dopant. Another sample was also prepared using the polyfurfuryl alcohol binder and the printing process described in this Example. This sample (sample 6) had 0.18 wt % carbon content. An image (reproduced in black and white) of the microstructure of the sample 6, which included 0.18 wt % carbon dopant, is shown in FIG. 6D.

When the parts were exposed to high temperature heating, the polyfurfuryl alcohol decomposed into carbon and then diffused into the Mn-steel build material. During cooling, the diffused carbon can segregate into carbide, inducing a phase change of the microstructure of the parts from a ferrite structure to a pearlite structure. The images provided in the FIG. 6 series show that the amount of pearlite crystal structure increased with increased carbon content (i.e., carbon doping).

Each of samples 1-5 was tested to determine the density (%) (using an Archimedes density meter), Young's modulus (GPa), the yield stress (MPa), the ultimate tensile strength (MPa), the elongation (%), and toughness (J/m³), and the results are summarized in Table 2 below. Young's modulus (GPa), the yield stress (MPa), the ultimate tensile strength (MPa), the elongation (%), and toughness (J/m³) were determined using a tensile test.

TABLE 2
Mechanical Properties of samples 1-5

| | Sample 4 | Sample 5 | Sample 1 | Sample 2 | Sample 3 |
|---|---|---|---|---|---|
| | (0 wt %) | (0.49 wt %) | (0.12 wt %) | (0.25 wt %) | (0.45 wt %) |
| Density (%) | 90.90 ± 0.25 | 90.89 ± 0.47 | 89.85 | 85.07 | 86.08 |
| Modulus (GPa) | 60.31 ± 3.84 | 64.70 ± 5.19 | 37.20 ± 9.47 | 79.58 ± 8.39 | 113.33 ± 7.74 |
| Yield stress (MPa) | 84.75 ± 2.89 | 346.54 ± 29.19 | 114.66 ± 16.90 | 170.93 ± 8.94 | 232.08 ± 1.83 |
| Ultimate tensile | 198.20 ± 16.47 | 474.82 ± 20.47 | 177.11 ± 4.16 | 234.67 ± 0.66 | 294.01 ± 3.55 |
| strength (MPa) | | | | | |
| Elongation (%) | 23.92 ± 0.51 | 9.69 ± 1.43 | 5.42 ± 0.185 | 2.96 ± 0.65 | 2.76 ± 0.06 |
| Toughness | 4180 ± 404 | 4332 ± 496 | 854.49 ± 12.40 | 659.37 ± 125.43 | 831.58 ± 41.73 |
| (Jm⁻³) | | | | | |

The results show that sample 3 (which included a carbon content of 0.45 wt %) exhibited the highest Young's Modulus of the samples tested. This means that sample 3 exhibited a resistance to elastic deformation compared to all of the other samples 1, 2, 4, and 5. The stiffness of sample 3 may render it able to withstand elongation during pulling. Example 3 also exhibited a higher yield stress and ultimate tensile strength compared to samples 1, 2, and 4. These results indicate that the sintered part formed using the polyfurfuryl alcohol binder and having a carbon content (of 0.45 wt %) can withstand more stress before deformation compared to samples 1, 2, and 4. These results also indicate that sample 3 can be stretched further before breaking compared to samples 1, 2 and 3. These particular mechanical properties increased in the samples with an increase in carbon content.

Notably, sample 5, which was formed using the carbon ink, exhibited a yield stress and an ultimate tensile strength that were higher compared to sample 3. This may be due to the small size of carbon nanoparticles in the carbon ink, which can readily diffuse into the build material. The green body of sample 5, however, was not as strong as sample 3.

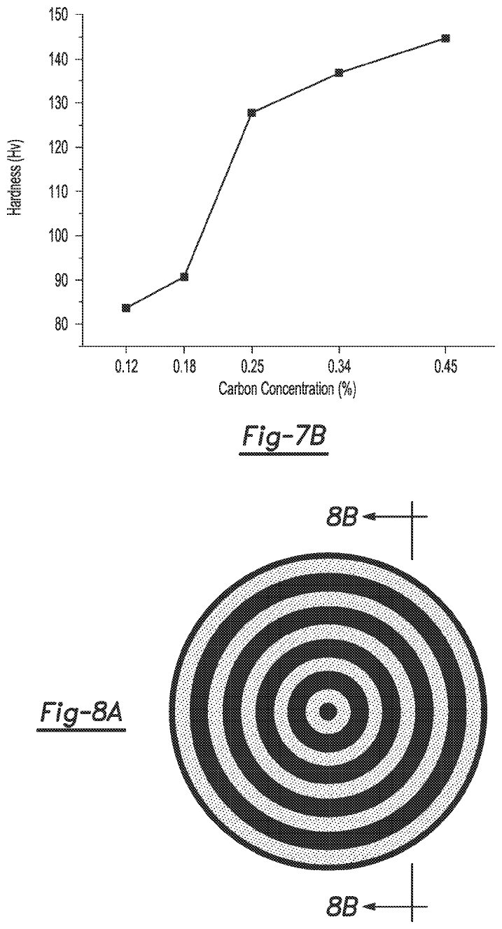

FIG. 7A is a stress-strain curve for samples 1-3. The stress-strain curve shows that control of the carbon dopant using the polyfurfuryl alcohol binder does affect the object's mechanical properties.

Still another sample was prepared using the polyfurfuryl alcohol binder and the printing process described in this Example. This sample (sample 8) had 0.34 wt % carbon content. Samples 1-3, 6, and 8 were tested for the Vickers' Hardness. The hardness was tested using a Vicker's hardness tester according to ASTM E92-17 (with a 0.2 mm interval). FIG. 7B is a graph showing how the carbon concentration in the samples affected the hardness (Hv). The graph of FIG. 7B shows that the hardness value increased as the carbon concentration increased.

### Site-Specific Carbon Doping of Mn-Steel Alloy

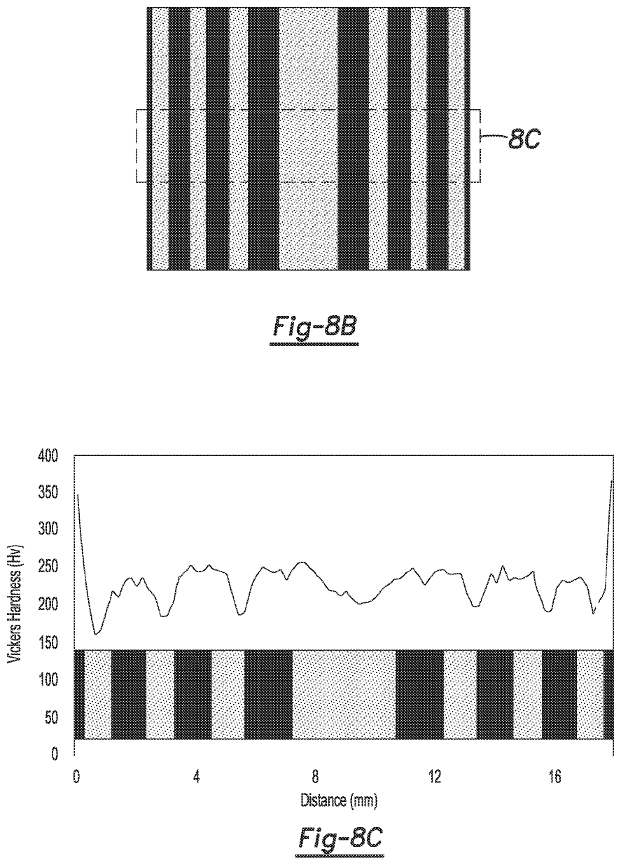

Another 3D object (sample 7) was prepared including site-specific carbon doping of the Mn-steel alloy. Sample 7 was prepared by applying a lesser amount of polyfurfuryl alcohol binder agent onto predetermined area(s) to be carbon deficient and a larger amount of polyfurfuryl alcohol binder agent onto predetermined area(s) to be carbon rich. The resultant object included areas having 0.12 wt % carbon content and other areas having 0.25 wt % carbon content. The carbon deficient areas alternated with the carbon rich areas in the final object. The object was designed to have an iso-stress property when undergoing tensile testing. Thus, the carbon deficient and the carbon rich areas were formed in strips and arranged alternatively with each strip having a 1 mm thickness and perpendicular to the pull direction of the tensile test. A schematic top view of sample 7 is shown in FIG. 8A, and a schematic cross-sectional view (taken along line 8B-8B of FIG. 8A) of sample 7 is shown in FIG. 8B. These green bodies were sintered using spark plasma sintering.

A portion of the object was removed (represented by the dashed line in FIG. 8B) and the Vickers' Hardness was tested (using a Vicker's hardness tester according to ASTM E92-17) across the removed portion with a 0.2 mm interval. The hardness was mapped across the removed portion of the object that was tested. The hardness map is shown in FIG. 8C, where peaks were observed at the carbon rich areas (shown in black at the bottom ribbon of the graph) and troughs/valleys were observed at the carbon deficient areas (shown in grey at the bottom ribbon of the graph).

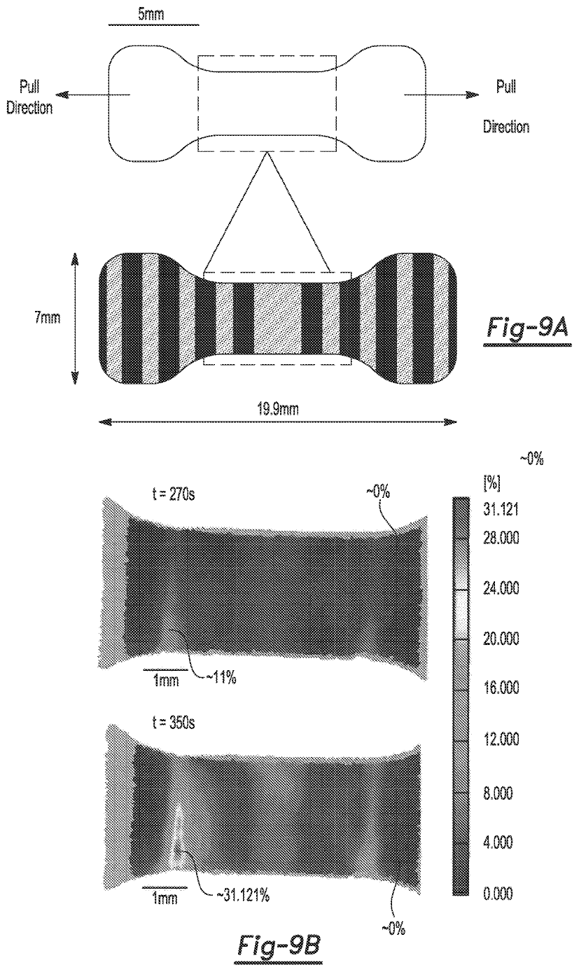

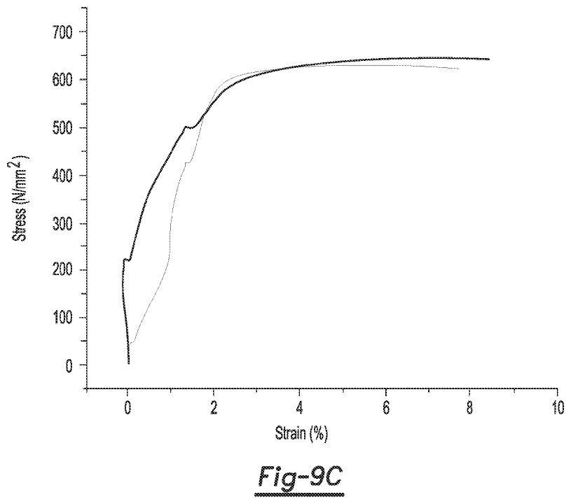

Two other portions of the object were removed, each in the shape of a dogbone as shown in the top portion in FIG. 9A, and tensile testing was performed on both of the dogbones. The profile of the carbon rich and carbon deficient areas of the dogbones is shown in the bottom portion of FIG. 9A. The top portion of FIG. 9A also shows the pull directions for the tensile testing. The tensile test was performed by clamping both ends of the dogbone with two clamps and pulling in opposite directions at a controlled strain rate of 0.001 mm/s.

A digital image correlation (DIC) was obtained on each of the dogbones to measure the surface strain during the tensile testing (tension at 270 s and at 350 s), and the results for one of the dogbones are reproduced in the grey scale in FIG. 9B. While not reproduced herein, the results for the other of the dogbones were similar. The carbon deficient regions had higher strain, which indicated higher ductility. Higher strain indicates that the portion of the part is more ductile

A stress-strain curve for both of the dogbones is shown in FIG. 9C. The results of the tensile test show that the carbon deficient areas were softer, as these areas experienced a higher strain for the same given stress. Breaking occurred at the left-most carbon deficient strip, which had the greatest elongation. Notably, the samples did not break in the middle because the middle area of each of the dogbones was a carbon rich region having higher strength compared to the carbon deficient areas.

It is to be understood that the ranges provided herein include the stated range and any value or sub-range within the stated range. For example, a range from about 1 wt % to about 10 wt % should be interpreted to include not only the explicitly recited limits of about 1 wt % to about 10 wt %, but also to include individual values, such as 5 wt %, 1.5 wt %, 9.7 wt %, 7.25 wt %, etc., and sub-ranges, such as from about 2.5 wt % to about 9.8 wt %, from about 9.2 wt % to about 9.7 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional (3D) printing method, comprising:
generating an intermediate object by:
forming a build material layer with build material particles;
based on data derived from a digital 3D object model, selectively applying a binder agent to at least a portion of the build material layer, the binder agent consisting of an organic solvent and polyfurfuryl alcohol dissolved in the organic solvent;
evaporating the organic solvent and precipitating the polyfurfuryl alcohol out of solution by heating the build material layer to a first temperature, thereby binding the build material particles with precipitated polyfurfuryl alcohol in the at least the portion of the build material layer; and
repeating the spreading, the selectively applying, and the heating; and
producing a carbon residue from the precipitated polyfurfuryl alcohol and throughout the intermediate object by heating the intermediate object to a second temperature.

2. The 3D printing method as set forth in claim 1 wherein the polyfurfuryl alcohol is a reaction product of furfuryl alcohol polymerized in the presence of an acid catalyst.

3. The 3D printing method as set forth in claim 1 wherein the build material particles are selected from the group consisting of metal particles, semi-metal particles, metal alloy particles, ceramic particles, and combinations thereof, and wherein the second temperature is above 400° C.

4. The 3D printing method as set forth in claim 1, further comprising sintering the intermediate object and forming a 3D object by heating the intermediate object to a third temperature that is higher than the second temperature.

5. The 3D printing method as set forth in claim 1, further comprising cooling the 3D object at a predetermined cooling rate.

6. The 3D printing method as set forth in claim 5, further comprising controlling the predetermined cooling rate, thereby controlling segregation of the carbon residue into carbide.

7. The 3D printing method as set forth in claim 1 wherein the build material particles are metal alloy particles, and the metal alloy particles are steel particles having a carbon content of 0.3% or less.

8. The 3D printing method as set forth in claim 1 wherein the binder agent is free of solids.

9. The 3D printing method as set forth in claim 1 wherein the organic solvent is selected from the group consisting of acetone, methanol, 2-methoxyethanol, isopropanol, toluene, ethyl acetate, butyl acetate, and dimethyl sulfoxide.

10. A three-dimensional (3D) printing method, comprising:
forming a build material layer with polymeric build material particles;
based on data derived from a digital 3D object model, selectively applying a binder agent to at least a portion of the build material layer, the binder agent being free of solids and consisting of an organic solvent and polyfurfuryl alcohol dissolved in the organic solvent; and
heating the build material layer.

11. The 3D printing method as set forth in claim 10 wherein the heating is performed at a temperature below a melting temperature of the polymeric build material particles and high enough to evaporate the organic solvent and precipitate the polyfurfuryl alcohol out of solution.

12. The 3D printing method as set forth in claim 10 wherein prior to heating, the method further comprises applying a detailing agent to an other portion of the build material layer.

13. A three-dimensional (3D) printing kit, comprising:
a build material composition including build material particles; and
a binder agent consisting of an organic solvent and polyfurfuryl alcohol dissolved in the organic solvent, wherein the binder agent is free of solids.

14. The 3D printing kit as set forth in claim 13 wherein the polyfurfuryl alcohol is the reaction product of furfuryl alcohol polymerized in the presence of an acid catalyst.

15. The 3D printing kit as set forth in claim 13 wherein the organic solvent is selected from the group consisting of acetone, methanol, 2-methoxyethanol, isopropanol, toluene, ethyl acetate, butyl acetate, and dimethyl sulfoxide.
